(19) United States
(12) Patent Application Publication
(10) Pub. No.: US 2026/0175694 A1
(43) Pub. Date: Jun. 25, 2026

(54) PROTECTIVE CIRCUIT FOR ELECTRIC LOADS

(71) Applicant: Daimler Truck AG, Leinfelden-Echterdingen (DE)

(72) Inventor: Joe BLACK, Portland, OR (US)

(21) Appl. No.: 19/427,060

(22) Filed: Dec. 19, 2025

Related U.S. Application Data
(60) Provisional application No. 63/736,717, filed on Dec. 20, 2024.

(51) Int. Cl. B60L 3/00; B60L 3/04; B60L 58/18; H02H 3/08; H02H 3/20; H02H 3/28; H02J 9/06

(52) U.S. Cl. CPC B60L 3/0046; B60L 3/04; B60L 58/18; H02H 3/08; H02H 3/207; H02H 3/28; H02J 9/06

(57) ABSTRACT

A system is described. The system comprises: a first power supply; a second power supply; and a power distribution module. The power distribution module is operable to determine one or more electric faults and protect one or more loads against the one or more electric faults. The power distribution module is further operable to switch between the first power supply and the second power supply, and vice versa, to provide an uninterrupted power output.

### CROSS-REFERENCE TO RELATED APPLICATIONS

The current application claims priority to, and the benefit of, U.S. Provisional Application No. 63/736,717 filed Dec. 20, 2024 and entitled “PROTECTIVE CIRCUIT FOR ELECTRIC LOADS,” the contents of which are hereby incorporated by reference in their entireties.

### FIELD OF THE INVENTION

The present disclosure relates generally to a protective circuit. More specifically, the present disclosure relates to a protective circuit for protecting components in a vehicle against electric faults such as overvoltage, undervoltage, reverse polarity, and overcurrent and provides uninterrupted power to prevent operational failure, malfunction, and degradation.

### BACKGROUND

Electronics have transformed modern vehicles by enabling the use of sensors and controllers for an increasingly broad range of functions. However, the growing role of electronics raises important operational considerations, for example the manner in which degradation of a component or components can impact vehicle control.

The automotive industry has recognized the above-mentioned issues and has developed a structure for risk classification called the automotive safety integrity level (ASIL). Through an ASIL rating, it can be demonstrated that a particular system or component within an automobile contains redundancies to enable proper vehicle control in the case of component degradation.

Given the rapidly increasing number of electrified and automatic systems being implemented in vehicles, there is an urgent and unmet need to develop components, systems, and methodologies capable to operate within the structure of particular ASIL ratings, to comply with the automotive industry's stringent focus on invulnerability.

### SUMMARY

The following paragraphs present a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, circuits, methods, and apparatus are presented that facilitate protecting automotive safety integrity level (ASIL) rated components in a vehicle against electric faults such as overvoltage, undervoltage, and overcurrent and providing uninterrupted power to prevent operational failure, malfunction, and degradation.

In an aspect, a system is described. The system comprises: a first power supply; a second power supply; and a power distribution module. The power distribution module is operable to determine one or more electric faults and protect one or more loads against the one or more electric faults. The power distribution module is further operable to switch between the first power supply and the second power supply, and vice versa, to provide an uninterrupted power output.

In one embodiment, the power distribution module comprises one or more Zener diodes; and one or more diodes. In an embodiment, a first anode of the one or more Zener diodes is connected to a ground terminal. A cathode of the one or more Zener diodes is connected to a second anode of the one or more diodes.

In one embodiment, the power distribution module comprises one or more overvoltage protection circuits; one or more undervoltage protection circuits; and one or more overcurrent protection circuits.

In one embodiment, the one or more overvoltage protection circuits comprises one or more crowbar circuits.

In one embodiment, the one or more overvoltage protection circuits comprises one or more Zener diodes.

In one embodiment, the one or more overvoltage protection circuits comprises one or more Zener regulators.

In one embodiment, the one or more overvoltage protection circuits comprises an array of Zener diodes.

In one embodiment, the one or more overvoltage protection circuits comprises one or more shunt regulators.

In one embodiment, the one or more overvoltage protection circuits comprises one or more metal-oxide-semiconductor field-effect transistors (MOSFETs).

In one embodiment, the one or more overvoltage protection circuits comprises one or more varistors.

In one embodiment, the one or more overvoltage protection circuits comprises one or more circuit breakers.

In one embodiment, the one or more overcurrent protection circuits comprises one or more fuses.

In one embodiment, the one or more overcurrent protection circuits comprises one or more surge protection thermistors.

In one embodiment, the one or more overcurrent protection circuits comprises one or more electromechanical circuit breakers.

In one embodiment, the one or more overcurrent protection circuits comprises one or more solid state switches.

In one embodiment, the one or more undervoltage protection circuits comprises one or more undervoltage relays.

In one embodiment, the one or more undervoltage protection circuits comprises one or more diodes.

In one embodiment, the first power supply is a power source that generates power.

In one embodiment, the second power supply is an energy storage system that stores power.

In one embodiment, the second power supply is one of a battery pack and a power bank.

In one embodiment, the first power supply is an energy storage system that stores power.

In one embodiment, the second power supply is a power source that generates power.

In one embodiment, the power distribution module further comprises one or more reverse polarity protection components.

In one embodiment, the one or more reverse polarity protection components comprises one or more diodes.

In one embodiment, the one or more loads comprises Automotive Safety Integrity Level (ASIL) rated systems.

In one embodiment, the one or more loads comprises a power steering of a vehicle.

In one embodiment, the power distribution module comprises a microprocessor that is configured to switch between the first power supply and the second power supply, and vice versa, to provide the uninterrupted power output.

In one embodiment, the power distribution module prevents flow of input power from the second power supply to the power distribution module when an input voltage to the power distribution module is less than voltage supplied by the second power supply.

In one embodiment, the one or more undervoltage protection circuits prevents flow of reverse polarity power to the power distribution module.

In one embodiment, the power distribution module switches from the second power supply to the first power supply to provide the uninterrupted power output to the one or more loads.

In one embodiment, the power distribution module comprises one or more Zener diodes; and a field-effect transistor (FET) array that comprises a plurality of first FETs and a plurality of second FETs. A plurality of first body diodes connected across the plurality of first FETs, respectively, and a plurality of second body diodes connected across the plurality of second FETs, respectively. An anode of the one or more Zener diodes is connected to a ground terminal. A cathode of the one or more Zener diodes is connected to a source terminal of the plurality of first FETs. A drain terminal of the plurality of first FETs is connected to a source terminal of the plurality of second FETs.

In one embodiment, the plurality of first FETs is connected in series with the plurality of second FETs, respectively.

In one embodiment, the FET array is a MOSFET array.

In one embodiment, the plurality of first FETs is a plurality of first Metal Oxide Semiconductor Field-effect Transistors (MOSFET) and the plurality of second FETs is a plurality of second Metal Oxide Semiconductor Field-effect Transistors (MOSFET).

In one embodiment, a drain terminal of the plurality of second FETs is connected to a positive terminal of a battery pack.

In one embodiment, the one or more loads are connected to the drain terminal of the plurality of second FETs through one or more overcurrent protection circuits.

In one embodiment, the power distribution module comprises a field-effect transistor (FET) array that comprises a plurality of body diodes connected across a plurality of FETs, respectively; and one or more diodes. A drain terminal of the plurality of FETs is connected to an anode of the one or more diodes.

In one embodiment, the FET array is a MOSFET array.

In one embodiment, the plurality of FETs is a plurality of Metal Oxide Semiconductor Field-effect Transistors (MOSFET).

In one embodiment, a cathode of the one or more diodes is connected to a positive terminal of a battery pack.

In one embodiment, the one or more loads are connected to the cathode of the one or more diodes through one or more overcurrent protection circuits.

In one embodiment, a source terminal of the plurality of FETs is connected to a ground terminal.

In one embodiment, the power distribution module comprises a first field-effect transistor (FET) array; and a second field-effect transistor (FET) array.

In one embodiment, the first field-effect transistor (FET) array comprises a plurality of first FETs and a plurality of second FETs. A plurality of first body diodes connected across the plurality of first FETs, respectively, and a plurality of second body diodes connected across the plurality of second FETs, respectively. A drain terminal of the plurality of first FETs is connected to a source terminal of the plurality of second FETs. The plurality of first FETs is connected in series with the plurality of second FETs, respectively.

In one embodiment, the second field-effect transistor (FET) array comprises a plurality of third body diodes connected across a plurality of third FETs, respectively.

In one embodiment, the plurality of third FETs is a plurality of MOSFETs.

In one embodiment, the system comprises a transient voltage suppressor (TVS) diode; a gate driver; an overvoltage protection element; and an undervoltage protection element.

In one embodiment, the transient voltage suppressor (TVS) diode is adapted to clamp charge source input voltage for a predefined duration.

In one embodiment, the system comprises an intelligent battery sensor (IBS).

In an aspect, a method is described. The method comprises: determining, by a power distribution module, whether an input power to the power distribution module is abnormal than voltage intended to be supplied to the power distribution module; communicating, by the power distribution module, a first signal to at least one electric component to prevent flow of the input power to one or more loads when the input power to the power distribution module is abnormal than the voltage intended to be supplied to the power distribution module; and communicating, by the power distribution module, a second signal to the at least one electric component to switch between a first power supply and a second power supply, and vice versa, to provide an uninterrupted power output.

In one embodiment, the method further comprises communicating, by the power distribution module, a third signal to the at least one electric component to protect the one or more loads against one or more electric faults.

In one embodiment, the power distribution module comprises one or more overvoltage protection circuits; one or more undervoltage protection circuits; and one or more overcurrent protection circuits.

In one embodiment, the power distribution module comprises a microprocessor that is configured to switch between the first power supply and the second power supply, and vice versa, to provide the uninterrupted power output.

In an aspect, a non-transitory computer readable storage medium, storing a sequence of instructions is executed. The non-transitory computer readable storage medium which when executed by a processor causes: determining whether an input power to a power distribution module is abnormal than voltage intended to be supplied to the power distribution module; communicating a first signal to at least one electric component to prevent flow of the input power to one or more loads when the input power to the power distribution module is abnormal than the voltage intended to be supplied to the power distribution module; and communicating a second signal to the at least one electric component to switch between a first power supply and a second power supply, and vice versa, to provide an uninterrupted power output.

In one embodiment, the non-transitory computer readable storage medium further causes: communicating a third signal to the at least one electric component to protect the one or more loads against one or more electric faults.

The methods and systems disclosed herein may be implemented by any means necessary for achieving various aspects to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a protective circuit for protecting loads against electric faults, according to one or more embodiments.

FIG. 2 illustrates a protective circuit for protecting loads against electric faults, according to one or more embodiments.

FIG. 3 illustrates a system having a protective circuit for protecting loads against electric faults, according to one or more embodiments.

FIG. 4 illustrates a system having a protective circuit for protecting loads against electric faults, according to one or more embodiments.

FIG. 5 illustrates a protective circuit that can replace the functionality of a combination of Zener diode and diode, according to one or more embodiments.

FIG. 6 illustrates an overvoltage protection circuit, according to one or more embodiments.

FIG. 7 illustrates an overvoltage protection circuit, according to one or more embodiments.

FIG. 8 illustrates a method for protecting loads against electric faults, according to one or more embodiments.

FIG. 9 illustrates a non-transitory computer readable storage medium for protecting loads against electric faults, according to one or more embodiments.

FIG. 10 illustrates a system for protecting loads against electric faults, according to one or more embodiments.

FIG. 11 illustrates a system for protecting loads against electric faults, according to one or more embodiments.

FIG. 12 illustrates a system for protecting loads against electric faults, according to one or more embodiments.

FIG. 13 illustrates a system for protecting loads against electric faults, according to one or more embodiments.

FIG. 14A illustrates a system for protecting loads against overvoltage, according to one or more embodiments.

FIG. 14B illustrates a circuit for protecting loads against overvoltage, according to one or more embodiments.

FIG. 15A illustrates a system for protecting loads against undervoltage, according to one or more embodiments.

FIG. 15B illustrates a circuit for protecting loads against undervoltage, according to one or more embodiments.

Other features of the present embodiments will be apparent from the accompanying drawings and from the detailed description that follows.

### DETAILED DESCRIPTION

Unless otherwise defined herein, scientific, and technical terms used herein shall have the meanings that are commonly understood by those of ordinary skill in the art. Further, unless otherwise required by context, singular terms shall include pluralities and plural terms shall include the singular. Generally, nomenclatures used in connection with, and techniques of, semiconductor processing described herein are those well-known and commonly used in the art.

The methods and techniques described herein are generally performed according to conventional methods well-known in the art and as described in various general and more specific references that are cited and discussed throughout the present specification unless otherwise indicated. The nomenclatures used in connection with, and the procedures and techniques of semiconductor device technology, semiconductor processing, and other related fields described herein are those well-known and commonly used in the art.

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Unless defined otherwise, all technical and scientific terms used herein have the same meaning as commonly understood by one with ordinary skill in the art.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the subject matter herein. In addition, any aspect or design described herein as an “example” and/or “exemplary” is not necessarily preferred or advantageous over other aspects or designs, nor does it preclude equivalent exemplary structures and techniques known to those of ordinary skill in the art.

No element act, or instruction used herein is critical or essential unless explicitly described as such. Furthermore, the term “set” includes items (e.g., related items, unrelated items, a combination of related items and unrelated items, etc.) and may be interchangeable with “one or more.” Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; or X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type, and/or amount, of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein and in the drawings are in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

The following terms and phrases, unless otherwise indicated, shall have the following meanings.

As used herein, the term “electric faults” refers to electrical abnormalities or electrical disturbances. For example, electric faults can include but are not limited to deviations from the normal operating conditions of an electrical system, presenting potential compromise to reliability of the system. The electric faults encompass various irregularities in the voltage, current, frequency, and waveform of electrical signals within a power system. Electric faults may include, for example, overvoltage, undervoltage, overcurrent, and reverse polarity, etc.

As used herein, the term “uninterrupted power” refers to a substantially continuous and reliable supply of electrical power without significant interruptions or disruptions. As used herein, “uninterrupted power” can refer to no interruptions or disruptions. This term is often associated with power sources or systems that are designed to provide consistent electrical power to critical loads, ASIL rated systems (e.g., vehicles, autonomous vehicles, semi-autonomous vehicles, etc.), ASIL rated loads (e.g., power steering, power brakes, etc.), ASIL rated components, or sensitive equipment, ensuring uninterrupted operation even in the event of power outages, electric faults, or disturbances.

As used herein, the term “protective circuit” refers to a component or system designed, including but not limited to safeguard electrical devices, circuits, or systems from damage due to overcurrent, overvoltage, reverse polarity, undervoltage, short circuits, or other electrical faults. The protective circuits may be important for maintaining the reliability and functionality of electrical systems, preventing/limiting degradation to equipment, and minimizing the risk of undesired events (e.g., malfunctioning, electrical hazards, and so on).

As used herein, the term “overvoltage” refers to a condition in an electrical system where the voltage exceeds a desired or rated operating level. Overvoltage can occur due to various factors, including but not limited to lightning strikes, power surges, switching transients, or electrical system faults. Overvoltage can lead to degradation of electrical and electronic equipment if not properly controlled or mitigated.

As used herein, the term “undervoltage” refers to a condition in an electrical system where the voltage falls below a desired or rated operating level. Undervoltage can, in particular circumstances, pose risks to electrical and electronic equipment, potentially leading to malfunctions, reduced performance, or even degradation.

As used herein, the term “reverse polarity” refers to a situation where the positive and negative terminals of a power source are connected in reverse to a device or circuit, causing the electrical polarity to be reversed. Reverse polarity can happen unintentionally, such as when connecting a battery, power supply, or plug to a device incorrectly.

As used herein, the term “TRISIL” refers to a type of electronic component used for surge protection in electronic circuits, specifically a type of thyristor surge protection device (TSPD). TRISIL combines characteristics of both a diode and a thyristor to provide fast, reliable protection against transient overvoltage events, such as lightning strikes or electrical surges.

The behavior of a TRISIL is similar to a SIDACtor (Silicon Diode for Alternating Current). SIDACtors are commonly used to protect against voltage surges and spikes that can damage sensitive electronic components.

As used herein, the term “Thyratron” refers to a specialized type of gas-filled tube that acts as a high-power electrical switch or amplifier. Thyratron operates based on the control of gas discharge within the tube. Thyratrons were widely used in electronics and telecommunications before the advent of solid state devices, particularly in applications requiring high voltage, high current, or fast switching speeds.

As used herein, the term “crowbar circuit” refers to a type of overvoltage protection circuit used in electronic systems to protect sensitive components from excessive voltage. The crowbar circuit is designed to rapidly short circuit the power supply output when the voltage exceeds a certain threshold, effectively “clamping” the voltage to a predefined level.

As used herein, the term “shorting device” refers to a component or mechanism used to create a short circuit in an electrical circuit. Shorting devices can serve various purposes in electronic systems, testing procedures, and otherwise. The shorting device may use a shunt as a low resistance pathway used to divert current away from the primary circuit. Shorting device can effectively create a short circuit across a specific component or section of a circuit, which can allow precise measurement or control of current flow.

As used herein, the term “electric load” refers to a component or portion of a circuit that consumes electric power. Electric loads vary widely in their power requirements, operating characteristics, and applications. Electric loads may include machinery, ASIL rated systems, automotive components, etc. Herein, “electric load” may be referred to simply as a “load” and is meant to convey any component or device or system that draws power from one or more power supplies. In some examples, a load can require uninterrupted power supply for operational integrity. The load may be a component or components in a vehicle. Providing overvoltage or undervoltage may lead to malfunction or degradation of a load which in turn can compromise integrity of e.g., a vehicle system.

As used herein, the term “power distribution module” refers to a device or component or circuit used in electrical systems to efficiently distribute electrical power to multiple loads or circuits. Power distribution modules are commonly employed in various applications, including automotive, marine, industrial, and telecommunications systems. The power distribution module may be a protective circuit designed or configured to protect loads against one or more electric faults such as overvoltage, undervoltage, and overcurrent. The “power distribution module” can be configured to provide uninterrupted, stable, and intended power.

As used herein, the term “power supply” or “power source” refers to an electronic device or system that provides electrical energy to one or more electric loads. Power supplies are essential components in a wide range of electronic and electrical systems, providing the necessary voltage, current, and power characteristics required by the load.

As used herein, the term “circuit” refers to a closed loop or path through which electric current can flow. The “circuit” consists of interconnected electrical components such as at least one of diodes, Zener diodes, regulators, fuses, alternators, power sources, etc.

As used herein, the term “gate” refers to the control electrode or control region that exerts an effect on a semiconductor region directly associated therewith, such that the conductivity characteristic of the semiconductor region is altered in a temporary manner, often resulting in an on-off type switching action.

IAs used herein, the term “TRIAC” refers to triode for alternating current (TRIAC). TRIAC is a semiconductor device that belongs to the thyristor family. TRIAC functions by allowing current to flow in either direction between its main terminals, known as MT1 and MT2, when a small current is applied to its gate terminal. Once triggered, the TRIAC remains conductive until the current through it drops below a certain threshold, typically during the zero-crossing of the AC waveform.

As used herein, the term “ground” in the context of an electrical circuit refers to a reference point in a circuit against which all other voltages are measured. “Ground” terminal serves as a common return path for electric current in an electrical circuit. A ground terminal refers to a specific point or terminal within a device or system that is designated for connection to the ground reference.

As used herein, the term “alternator” refers to an electromechanical device used in vehicles and other applications to convert mechanical energy into electrical energy. Alternators are commonly used in automotive applications to recharge the vehicle's battery and power electrical systems such as lights, ignition, air conditioning, and audio systems. Alternators are also used in various industrial, marine, and stationary power generation applications where a reliable source of electrical power is required.

As used herein, the term “battery pack” or “power bank” as used herein refers to a set of any number of batteries or individual cells of a battery. The term “battery pack” encompasses a set of identical or a set of non-identical batteries. The batteries in the battery pack may be configured in a series, parallel, or a mixture to deliver the desired power for some amount of time (e.g., kWh).

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality. As used herein, a module can be a portion or an entirety of a software program or application.

The term “vehicle” as used herein refers to a thing used for transporting people or goods. Automobiles, cars, trucks, buses, etc., are examples of vehicles.

As used herein, the term “component” broadly construes hardware, firmware, and/or a combination of hardware, firmware, software, and circuitry.

The descriptions of the one or more embodiments are for purposes of illustration but are not exhaustive or limiting to the embodiments described herein. Many modifications and variations will be apparent to those of ordinary skill in the art without departing from the scope and spirit of the embodiments described. The terminology used herein best explains the principles of the embodiments, the practical application and/or technical improvement over technologies found in the marketplace, and/or to enable others of ordinary skill in the art to understand the embodiments described herein.

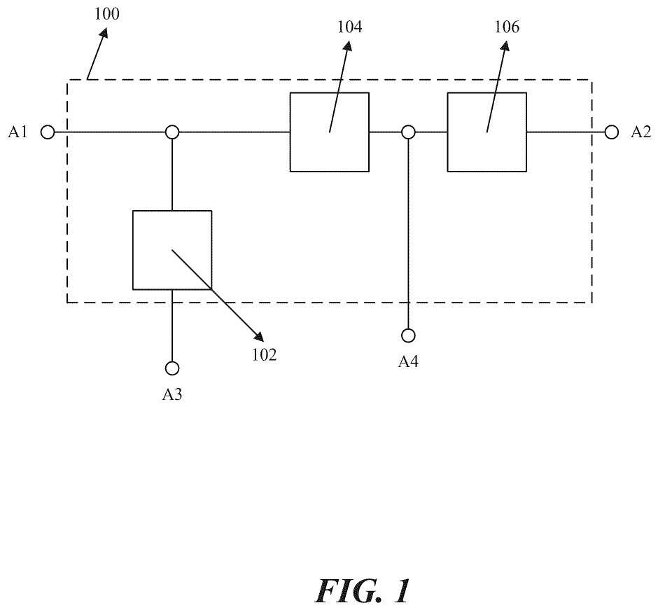

As an example, FIG. 1 illustrates a protective circuit 100 for protecting loads against electric faults, according to one or more embodiments. The protective circuit 100 is a power distribution module. The power distribution module provides protection to the one or more loads against electric faults. The one or more loads may be Automotive Safety Integrity Level (ASIL) rated systems. For example, the one or more loads comprises a power steering of a vehicle. The electric fault may be at least one of overvoltage, undervoltage, overcurrent, reverse polarity, etc. The power distribution module comprises one or more overvoltage protection circuits 102, one or more undervoltage protection circuits 104, and one or more overcurrent protection circuits 106.

In an embodiment, the one or more overvoltage protection circuits 102 comprises one or more crowbar circuits. In another embodiment, the one or more overvoltage protection circuits 102 comprises one or more Zener diodes. In another embodiment, the one or more overvoltage protection circuits 102 comprises one or more Zener regulators. In another embodiment, the one or more overvoltage protection circuits 102 comprises an array of Zener diodes. In another embodiment, the one or more overvoltage protection circuits 102 comprises one or more shunt regulators. In another embodiment, the one or more overvoltage protection circuits 102 comprises one or more metal-oxide-semiconductor field-effect transistors (MOSFETs). In another embodiment, the one or more overvoltage protection circuits 102 comprises one or more varistors. In another embodiment, the one or more overvoltage protection circuits 102 comprises one or more circuit breakers.

In one embodiment, the one or more overcurrent protection circuits 106 comprises one or more fuses. In another embodiment, the one or more overcurrent protection circuits 106 comprises one or more surge protection thermistors. In another embodiment, the one or more overcurrent protection circuits 106 comprises one or more electromechanical circuit breakers. In another embodiment, the one or more overcurrent protection circuits 106 comprises one or more solid state switches. In another embodiment, the one or more undervoltage protection circuits 104 comprises one or more undervoltage relays. In another embodiment, the one or more undervoltage protection circuits 104 comprises one or more diodes.

The power distribution module comprises terminals A1, A2, A3, and A4. The terminal A1 is connected to a first power supply. The first power supply may be an alternator or any other power source or energy storage. The terminal A2 is connected to a load which needs to be protected against the electric faults. The terminal A3 is connected to the ground. The terminal A4 is connected to a second power supply. The second power supply may be an alternator or any other power source or energy storage. The second power supply being directly connected to the protective circuit is protected by the one or more overvoltage protection circuits 102 and the one or more undervoltage protection circuits 104. The load connected via the terminal A2 has limited protection from the second power supply connected via the terminal A4. The second power supply provides the protected, dedicated, and robust backup to the load.

In one embodiment, the first power supply is a power source that generates power and the second power supply is an energy storage system that stores power. The second power supply may be a battery pack. In another embodiment, the first power supply is an energy storage system that stores power and the second power supply is a power source that generates power. The power distribution module may comprise one or more reverse polarity protection components. The one or more reverse polarity protection components may comprise one or more diodes.

In an aspect, the system comprises a microprocessor. The microprocessor is configured to communicate a first command to a first component (e.g., voltage sensor, a current sensor, etc.) to determine whether an input power to the power distribution module is abnormal than voltage intended to be supplied to the power distribution module. The microprocessor is configured to communicate a second command to a second component (e.g., relay, circuit breaker, MOSFET, Insulated Gate Bipolar Transistor (IGBT), contactors, thyristors, solenoids, latching relays, smart switches, etc.) to prevent flow of the input power to one or more loads when the input power to the power distribution module is abnormal than the voltage intended to be supplied to the power distribution module. The microprocessor is configured to communicate a third command to a third component (e.g., MOSFET, relay, power management integrated circuit, multiplexer, contactors, thyristors, etc.) to switch between the first power supply and the second power supply, and vice versa, to provide the uninterrupted power output.

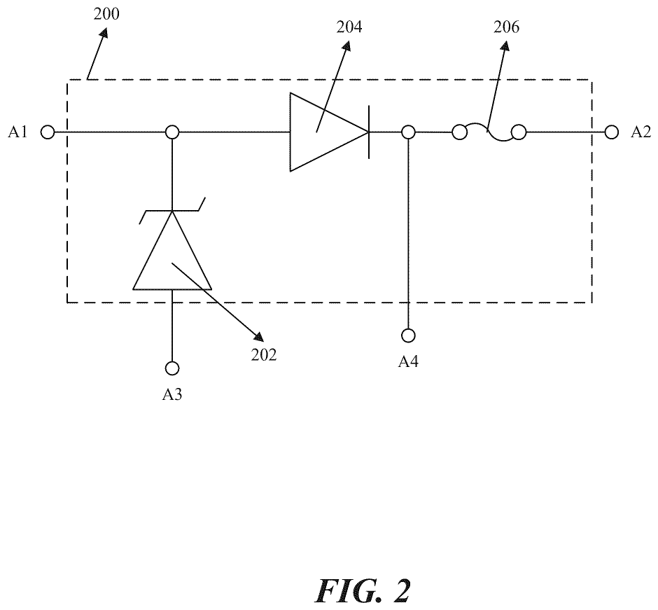

As an example, FIG. 2 illustrates a protective circuit 200 for protecting loads against electric faults, according to one or more embodiments. The protective circuit 200 is a power distribution module. The power distribution module provides protection to the loads against electric faults. In an embodiment, the loads may be the automotive safety integrity level (ASIL) rated components in a vehicle. The power distribution module is adapted to protect the automotive safety integrity level (ASIL) rated component against electric faults such as overvoltage, undervoltage, reverse polarity, and overcurrent and provides uninterrupted power to prevent operational failure, malfunction, and degradation. The electric fault may be at least one of overvoltage, undervoltage, overcurrent, reverse polarity, etc. The power distribution module comprises a Zener diode 202, a diode 204, and a fuse 206. The power distribution module comprises terminals A1, A2, A3, and A4. The terminal A1 is connected to a first power supply. The first power supply may be an alternator or any other power source or energy storage. The terminal A2 is connected to a load which needs to be protected against the electric faults. The terminal A3 is connected to the ground. The terminal A4 is connected to a second power supply. The second power supply may be an alternator or any other power source or energy storage.

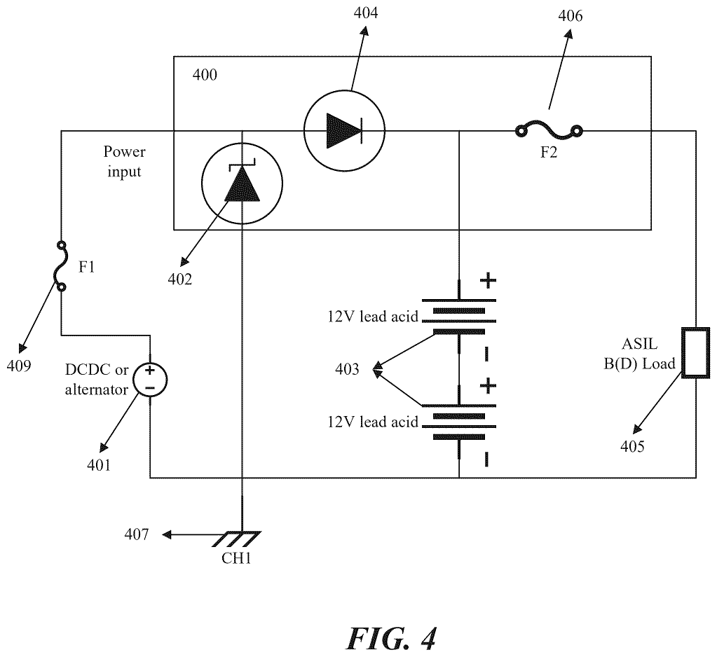

The Zener diode 202 provides protection to the loads against the overvoltage. The diode 204 provides protection to the loads against the undervoltage. The fuse 206 provides protection to the loads against the overcurrent. The diode 204 further provides protection against the reverse polarity of the first power supply connected via the terminal A1. In an embodiment, a first anode of the Zener diode 202 is connected to a ground terminal and a cathode of the Zener diode 202 is connected to a second anode of the diode 204. The working of the protective circuit 200 is detailed below in FIG. 4.

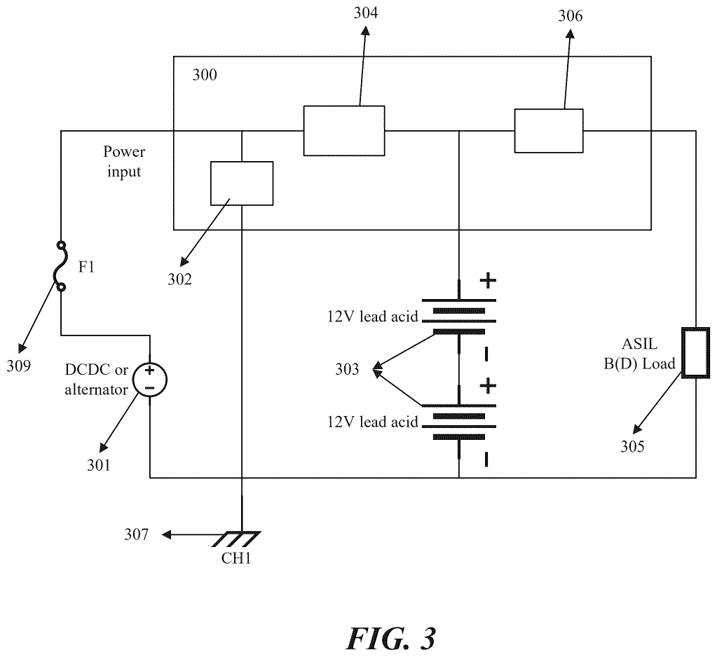

As an example, FIG. 3 illustrates a system having a protective circuit 300 for protecting loads against electric faults, according to one or more embodiments. The system comprises a first power supply 301, a second power supply 303, and a protective circuit 300. The protective circuit 300 comprises a power distribution module. The power distribution module is operable to determine electric faults across the system and protect load 305 (e.g., ASIL rated components in a vehicle) against the electric fault. The electric fault may be at least one of overvoltage, undervoltage, reverse polarity, overcurrent, etc.

The power distribution module is also known as “Joule Blocking Distribution Module (JBDM).” The power distribution module is configured to prevent overvoltage, undervoltage, reverse polarity, and overcurrent at its output to the load 305 (e.g., ASIL rated components in a vehicle) which it protects. The power distribution module is further operable to provide uninterrupted power to the load 305. In case, there is an electric fault with the first power supply 301, the power distribution module supplies uninterrupted power to the load from the second power supply 303, and vice versa. The power distribution module may supply uninterrupted power for a predefined period of time. In an embodiment, the load 305 may be Automotive Safety Integrity Level (ASIL) rated systems or components or devices. For example, the load 305 may be an ASIL B (D) load.

Automotive Safety Integrity Level (ASIL) is a key component of ISO 26262. ASIL is used to measure the risk of a specific system component. The more complex the system, the greater the risk of systematic failures and random hardware failures. Automotive Safety Integrity Level (ASIL) comprises four values, namely A, B, C, and D. ASIL A is the minimum level of risk and ASIL D is the maximum, starting from A to D, the compliance requirements get stricter. The ASIL classification may vary depending on the application for which the system is used for. As an example, a few loads and their respective ASIL classification for an application are listed below. It is to be understood that this list is meant to be illustrative and non-limiting.
Rear View Camera—ASIL-B;
Rear lights—ASIL-A;
Instrument Cluster—ASIL-B;
Airbag—ASIL-D;
Engine Management—ASIL-C to D;
Headlights—ASIL-B;
Radar Cruise Control—ASIL-B;
Electric Power Steering—ASIL-D;
Vision ADAS—ASIL-B;
Active Suspension—ASIL-B to C;
Antilock Braking—ASIL-D; and
Brake lights—ASIL-B.

The power distribution module operates in conjunction with the first power supply 301 (e.g., alternator), the second power supply 303 (e.g., a battery pack), and a connection to ground terminal 307 (e.g., common low voltage DC ground). The protective circuit 300 may be used in heavy-duty truck platforms for protecting at least one electronic component (e.g., ASIL rated components) in a vehicle. The power distribution module receives input power through terminal A1 via a first fuse 309 from the first power supply. The power distribution module provides uninterrupted output power via terminal A2 to the load 305. The power distribution module is connected to the ground terminal 307 via terminal A3. The power distribution module is connected to the second power supply 303 via terminal A4. The second power supply 303 is connected parallel to the load 305.

In one embodiment, the power distribution module comprises one or more overvoltage protection circuits 302, one or more undervoltage protection circuits 304, and one or more overcurrent protection circuits 306. In an embodiment, the one or more overvoltage protection circuits 302, within the power distribution module, may be one of a Zener diode, an array of diodes, a Zener regulator, and a Zener crowbar circuit. The one or more undervoltage protection circuits 304, within the power distribution module, may be one of a diode, an array of diodes, and/or an ideal diode. The one or more overcurrent protection circuits may be a fuse.

The one or more overvoltage protection circuits 302 are adapted to protect the load against overvoltage for the system by diverting current to ground terminal 307. The one or more overvoltage protection circuits 302 may withstand all voltages, including transients when used in combination with the rest of the components.

In an embodiment, the one or more overvoltage protection circuits 302 prevent overvoltage above 35 volts. The one or more overvoltage protection circuits 302 may act alone or in combination with the first fuse 309 to protect the load against the overvoltage by diverting current to ground terminal 307. The one or more undervoltage protection circuits 304 prevent current flow from the first power supply 301 to the input of the power distribution module when the input power from the first power supply 301 is less than the voltage supplied by the second power supply 303. The one or more overvoltage protection circuits 302 has a voltage rating that can repeatedly accept transients. The one or more overcurrent protection circuits 306 is adapted to protect the vehicle from hazards due to overcurrent.

As an example, FIG. 4 illustrates a system having a protective circuit 400 for protecting loads against electric faults, according to one or more embodiments. The system comprises a first power supply 401, a second power supply 403, and a protective circuit 400. The protective circuit 400 comprises a power distribution module. The power distribution module is operable to determine electric faults across the system and protect load 405 (e.g., ASIL rated component in a vehicle) against the electric fault. The electric fault comprises at least one of overvoltage, undervoltage, reverse polarity, overcurrent, etc.

The power distribution module is also known as “Joule Blocking Distribution Module (JBDM).” The power distribution module is configured to prevent overvoltage, undervoltage, reverse polarity, and overcurrent at its output to the load 405 which it protects. The power distribution module is further operable to provide uninterrupted power to the load 405. In case, there is an electric fault with the first power supply 401, the power distribution module supplies uninterrupted power to the load 405 from the second power supply 403, and vice versa. The power distribution module may supply uninterrupted power for a predefined period of time. In an embodiment, the load 405 may be Automotive Safety Integrity Level (ASIL) rated systems or components or devices. For example, the load 405 may be an ASIL B (D) load.

Automotive Safety Integrity Level (ASIL) is a key component of ISO 26262. ASIL is used to measure the risk of a specific system component. The more complex the system, the greater the risk of systematic failures and random hardware failures. Automotive Safety Integrity Level (ASIL) comprises four values, namely A, B, C, and D. ASIL A is the minimum level of risk and ASIL D is the maximum, starting from A to D, the compliance requirements get stricter.

The power distribution module operates in conjunction with the first power supply 401 (e.g., alternator), the second power supply 403 (e.g., a battery pack), and a connection to ground terminal 407 (common low voltage DC ground). The power distribution module may be used in heavy-duty truck platforms. The power distribution module receives input power through terminal A1 via a first fuse 409 from the first power supply 401. The power distribution module provides uninterrupted output power via terminal A2 to the load 405. The power distribution module is connected to the ground terminal 407 via terminal A3. The second power supply 403 is connected parallel to the load 405.

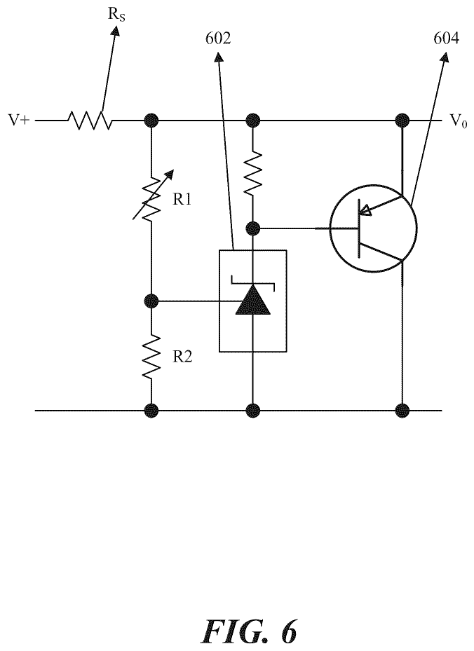

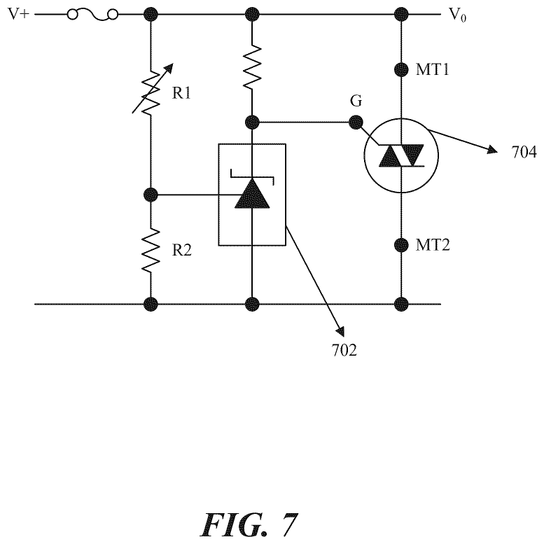

In one embodiment, the power distribution module comprises a Zener diode 402, a diode 404, and a second fuse 406. In an embodiment, the Zener diode 402, within the power distribution module, may be one of an array of diodes, a Zener regulator (as shown in FIG. 6), and a crowbar circuit (as shown in FIG. 7). In another embodiment, the diode 404, within the power distribution module, may be one of an array of diodes, and an ideal diode.

The Zener diode 402 is adapted to protect the load 405 against overvoltage for the system by diverting current to ground terminal 407. The Zener diode 402 may be accurate to +/−1V in its clamping characteristics within some specified temperature range. For example, in a temperature range typical for a truck environment (e.g., from about −40 C to about 85 C). In an embodiment, the Zener diode 402 does not sink more than 200 μA (i.e., no sink (0 μA sink up to 200 μA)) when less or equal to 32V is present.

The Zener diode 402 may withstand all voltages, including transients when used in combination with the rest of the components.

In an embodiment, the Zener diode 402 prevents overvoltage above some threshold voltage (e.g., greater than 20 volts, or 24 volts, or 32 volts, or 48 volts, or 52 volts). The Zener diode 402 may act alone or in combination with the first fuse 409 to protect the load 405 against the overvoltage. In an embodiment, the anode of the Zener diode 402 is connected to a ground terminal 407 and the cathode of the Zener diode 402 is connected to an anode of the diode 404. The input power from the first power supply 401 enters the cathode of the Zener diode 402. When the input power from the first power supply 401 exceeds some voltage threshold (i.e., overvoltage) (e.g., greater than 20 volts, or 24 volts, or 32 volts, or 48 volts, or 52 volts) in case of an electric fault or any other circumstances, the Zener diode 402 protects the load 405 against overvoltage by diverting the input power to the ground terminal 407. The diode 404 does not conduct when the voltage at the anode is less than the voltage at the cathode. The input power from the first power supply 401 is not fed to the load 405 as soon as the diode 404 stops conducting.

In such a scenario, the power distribution module supplies the power uninterruptedly from the second power supply 403 to the load 405 as soon as the power from the first power supply 401 is diverted to the ground terminal 407. When the input power from the first power supply 401 is normal (e.g., voltage above second power supply), the diode 404 conducts and provides the input power from the first power supply 401 to the load 405. When the input power from the first power supply 401 is low (e.g., voltage below the second power supply), the diode 404 does not conduct and no input power from the first power supply 401 is provided to the load 405. The power distribution module supplies power directly from the second power supply 403 to the load 405. The diode 404 provides protection against undervoltage when assuming that the battery pack (i.e., second power supply) connected can provide sufficient power to the output of the load while maintaining sufficient voltage. The diode 404 prevents current flow from the first power supply 401 to the input of the power distribution module when the input power from the first power supply 401 is less than the voltage supplied by the second power supply 403. In an embodiment, the diode 404 is tested to ensure reverse voltage characteristics. The diode 404 is capable of having less than 200 μA as leakage from battery to the input at 0V. The diode 404 has a current rating that the first fuse 409 and second fuse 406 can protect the diode 404 against damage with respect to battery, load 405, and wiring characteristics. The diode 404 has a voltage rating that can repeatedly accept transients.

The first fuse 409 and the second fuse 406 are adapted to protect the load 405 from the overcurrent either from the first power supply 401 and/or the second power supply 403. In an embodiment, the power distribution module takes account of ampere squared seconds (12t), a measure of thermal energy that results from current flow, and other losses with respect to first fuse 409 to ensure robustness of the Zener diode 402. Said another way, the power distribution module needs to be tougher (i.e., more robust) than the fuse that protects it.

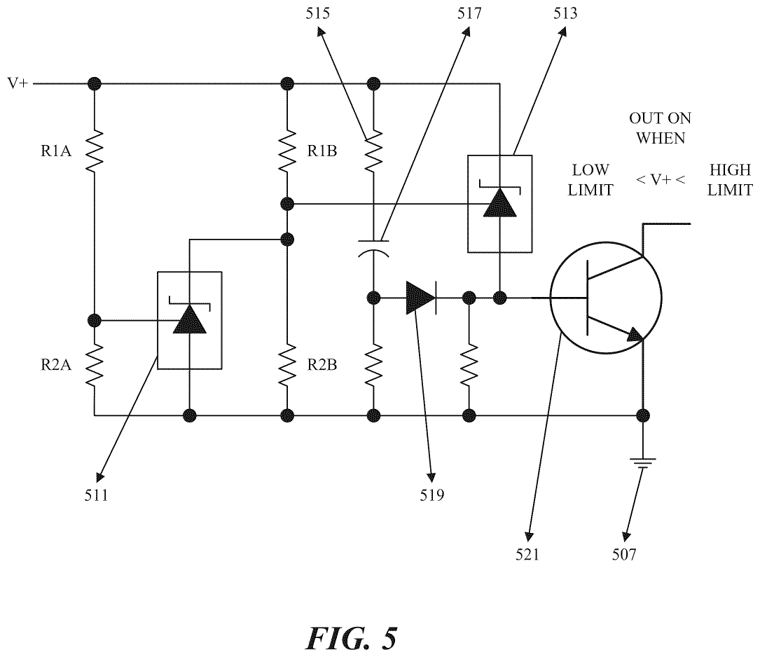

As an example, FIG. 5 illustrates a protective circuit that can replace the functionality of a combination of Zener diode and diode, according to one or more embodiments. The protective circuit shown in FIG. 5 comprises Zener shunt regulators which combines the functionality of both the Zener diode and diode.

The resistor divider of R1A and R2A shown in FIG. 5 provides the reference voltage for the first Zener regulator 511. The divider is set so that during normal operating conditions, the voltage across R2A is slightly lower than V_{REF} of the first Zener regulator 511. Since this voltage is below the minimum reference voltage of the first Zener regulator 511, it remains off and very little current is conducted through the first Zener regulator 511. If the supply voltage increases, the voltage across R2A exceeds V_{REF} and the cathode of the first Zener regulator 511 begins to draw current.

The resistance R2A is connected in series with the anode terminal of the first Zener regulator 511 to limit the current when the first Zener regulator 511 is reversed biased. The anode terminal of the first Zener regulator 511 is connected to ground 507. The resistance R1B and R2B limits the power from the cathode terminal of the first Zener regulator 511. The power from the cathode terminal of the first Zener regulator 511 is fed as a reference voltage to the second Zener regulator 513 via the reference pin. The voltage at R2A and R2B is slightly lower than V_{REF} of the second Zener regulator 513. Based on the V_{REF} of the second Zener regulator 513, the second Zener regulator 513 reverse biases or forward biases and provides power to the base terminal of the transistor. The second Zener regulator 513, when forward biased, provides power to the base terminal of the transistor 521 through a resistor 515, a capacitor 517, and a diode 519. The diode 519 conducts and provides power to the base terminal of the transistor 521. The power received from the base terminal is used to activate the transistor 521. The emitter terminal of the transistor 521 is connected to the ground 507. The collector terminal of the transistor 521 is used to provide power output to the load. The protective circuit is adapted to provide uninterrupted power output to the load.

$$LOW LIMIT = {V}_{REF} ( 1 + \frac{R 1 B}{R 2 B} ) + {V}_{BE} \\ HIGH LIMIT = {V}_{REF} ( 1 + \frac{R 1 A}{R 2 A} )$$

As an example, FIG. 6 illustrates an overvoltage protection circuit, according to one or more embodiments. The overvoltage protection circuit shown in FIG. 6 is a high current shunt regulator circuit. The high current shunt regulator circuit comprises a Zener diode 602. The Zener diode 602 is adapted to control the transistor 604. The Zener diode 602 receives power as reference voltage from an energy storage or a power source via a reference pin.

The resistor divider of R1 and R2 provides the reference voltage for the Zener diode 602. The divider is set so that during normal operating conditions, the voltage across R2 is slightly lower than V_{REF} of the Zener diode 602. Since this voltage is below the minimum reference voltage of the Zener diode 602, Zener diode 602 remains off and very little current is conducted through the Zener diode 602. If the supply voltage increases, the voltage across R2 exceeds V_{REF} and the cathode of the Zener diode 602 begins to draw current and the power is fed to the base terminal of the transistor 604. The transistor 604 gets activated upon receiving the power via the base terminal.

An external series resistor (R_{S}) is connected between the supply voltage and cathode pin of the Zener diode 602. R_{S} determines the current that flows through the load (I_{LOAD}) and the Zener diode (I_{Z}). Since load current and supply voltage may vary, R_{S} must be small enough to supply at least the minimum acceptable I_{Z} to the Zener diode 602 even when the supply voltage is at its minimum and the load current is at its maximum value. When the supply voltage is at its maximum and I_{LOAD} is at its minimum, R_{S} is large enough so that the current flowing through the Zener diode 602 is less than 100 mA. R_{S} is selected based on the supply voltage, (V+), the desired load and operating current, (I_{LOAD} and I_{Z}), and the output voltage V_{O}.

$${V}_{O} = ( 1 + R 1 / R 2 ) {V}_{REF}$$

As an example, FIG. 7 illustrates an overvoltage protection circuit, according to one or more embodiments. The overvoltage protection circuit shown in FIG. 7 is a crowbar circuit. The crowbar circuit comprises a Zener diode. The Zener diode receives power from an energy storage or a power source via a reference pin. The Zener diode receives power as reference voltage through a variable resistor R1. The resistance value of the variable resistor R1 is adjustable according to the specification of the load. The power is fed to the TRIAC 704 via the cathode of the Zener diode. The TRIAC gets activated upon receiving the power.

The overvoltage protection circuit shown in FIG. 7 is one example of implementation. There are other possible implementations similar to the circuit shown in FIG. 7. The overvoltage protection circuit shown in FIG. 7 may use an LM431 adjustable Zener regulator 702 to control the gate of the TRIAC 704. The resistor divider of R1 and R2 provides the reference voltage for the LM431 adjustable Zener regulator 702. The divider is set so that during normal operating conditions, the voltage across R2 is slightly lower than V_{REF} of the LM431 adjustable Zener regulator 702. Since this voltage is below the minimum reference voltage of the LM431, it remains off and very little current is conducted through the LM431 adjustable Zener regulator 702. If the cathode resistor R2 is sized accordingly, very little voltage is dropped across it and the TRIAC 704 gate terminal is essentially at the same potential as main terminal 1, keeping the TRIAC 704 off. If the supply voltage increases, the voltage across R2 exceeds V_{REF} and the cathode of the LM431 adjustable Zener regulator 702 begins to draw current. The voltage at the gate terminal is pulled down, exceeding the gate trigger voltage of the TRIAC 704 and latching it on.

As soon as the voltage is applied to the gate terminal of the TRIAC 704, the TRIAC 704 starts conducting and allowing current to flow between terminals MT1 and MT2. TRIAC 704 can be triggered in four quadrants based on the polarity of the voltage across MT1 and MT2 and the gate current:
Quadrant I: MT2 positive with respect to MT1, gate current positive with respect to MT1.
Quadrant II: MT2 positive with respect to MT1, gate current negative with respect to MT1.
Quadrant III: MT2 negative with respect to MT1, gate current negative with respect to MT1.
Quadrant IV: MT2 negative with respect to MT1, gate current positive with respect to MT1.

The TRIAC is most sensitive in Quadrants I and III, making these the most common modes of operation. In one embodiment, by adjusting the trigger point, the TRIAC 704 controls the average voltage applied to a load, thus controlling its operation. The trigger point may be adjusted through the LM431 adjustable Zener regulator 702. The TRIAC 704, by controlling the average voltage applied to a load, provides protection against an overvoltage condition.

The crowbar circuit is an electrical circuit used for preventing an overvoltage or surge condition of a power supply unit from damaging the circuits attached to the power supply. It operates by putting a short circuit or low resistance path across the voltage output (Vₒ), like dropping a crowbar across the output terminals of the power supply. Crowbar circuits are frequently implemented using a thyristor, TRIAC, Trisil, or thyratron as the shorting device.

$${V}_{LIMIT} = ( 1 + R 1 / R 2 ) {V}_{REF}$$

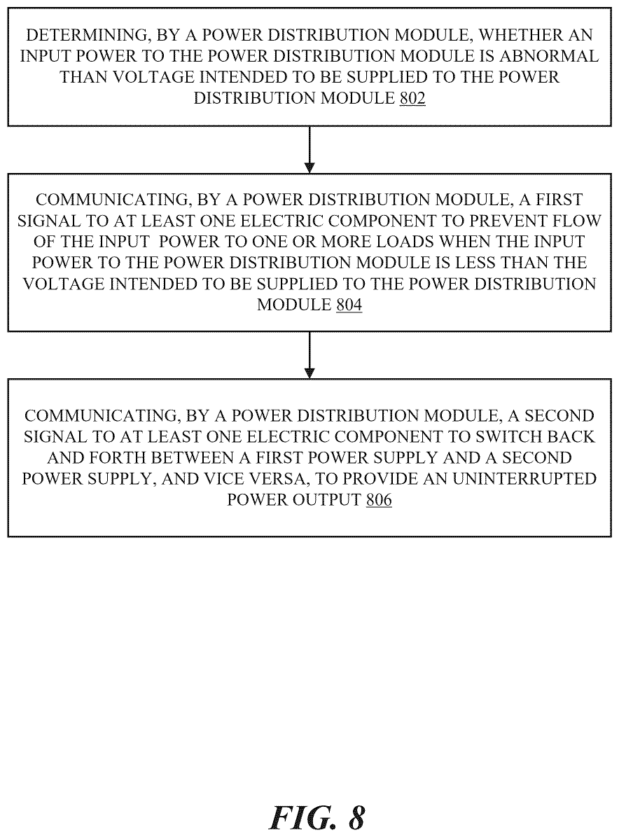

As an example, FIG. 8 illustrates a method for protecting loads against electric faults, according to one or more embodiments. The method comprises the following technical steps: determining, by a power distribution module, whether an input power to the power distribution module is abnormal than voltage intended to be supplied to the power distribution module (at step 802); communicating a first signal to at least one electric component to prevent flow of the input power to the one or more loads when the input power to the power distribution module is less than the voltage intended to be supplied to the power distribution module (at step 804); and communicating a second signal to the at least one electric component to switch between a first power supply and a second power supply, and vice versa, to provide an uninterrupted power output (at step 806).

In one embodiment, the method further comprises communicating a third signal to the at least one electric component to protect the one or more loads, by the power distribution module, from at least one of overvoltage, overcurrent, and reverse polarity. The third signal is communicated to protect the one or more loads from other possible faults that may occur with the one or more loads. In another embodiment, the power distribution module comprises one or more overvoltage protection circuits; one or more undervoltage protection circuits; and one or more overcurrent protection circuits.

In one embodiment, the system comprises a microprocessor. The microprocessor is configured to communicate a first command to a first component (e.g., voltage sensor such as a resistive type sensor, capacitor type sensor, contact voltage sensors, non-contact voltage sensors, analog voltage sensors, digital voltage sensors, voltage divider circuit, etc.) to determine whether an input power to the power distribution module is abnormal than voltage intended to be supplied to the power distribution module. The microprocessor is configured to communicate a second command to a second component (e.g., relay, circuit breaker, MOSFET, Insulated Gate Bipolar Transistor (IGBT), contactors, thyristors, solenoids, latching relays, smart switches, etc.) to prevent flow of the input power to one or more loads when the input power to the power distribution module is abnormal than the voltage intended to be supplied to the power distribution module. The microprocessor is configured to communicate a third command to a third component (e.g., MOSFET, relay, power management integrated circuit, multiplexer, contactors, thyristors, etc.) to switch between the first power supply and the second power supply, and vice versa, to provide the uninterrupted power output to the one or more loads. In an embodiment, the microprocessor is configured to protect the one or more loads from at least one of overvoltage, overcurrent, reverse polarity, undervoltage, etc, and provide uninterrupted power to the one or more loads.

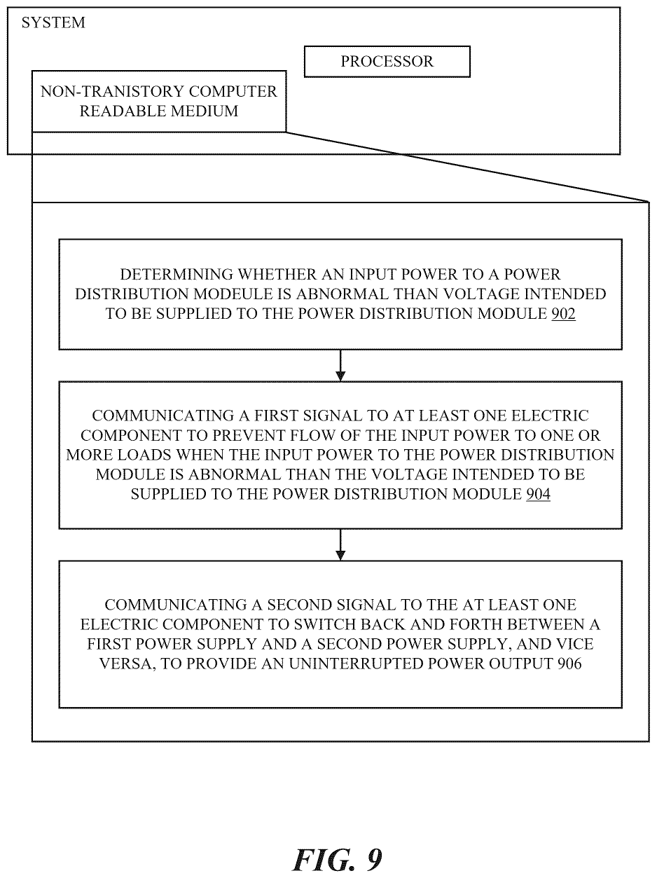

As an example, FIG. 9 illustrates a non-transitory computer readable storage medium for protecting loads against electric faults, according to one or more embodiments. The non-transitory computer readable storage medium storing a sequence of instructions, which when executed by a processor causes: determining whether an input power to a power distribution module is abnormal than voltage intended to be supplied to the power distribution module (at step 902); communicating a first signal to at least one electric component to prevent flow of the input power to the one or more loads when the input power to the power distribution module is abnormal than the voltage intended to be supplied to the power distribution module (at step 904); and communicating a second signal to the at least one electric component to switch between a first power supply and a second power supply, and vice versa, to provide an uninterrupted power output (at step 906).

In one embodiment, the non-transitory computer readable storage medium further causes: communicating a third signal to the at least one electric component to protect the one or more loads from at least one of overvoltage, overcurrent, reverse polarity, undervoltage, etc.

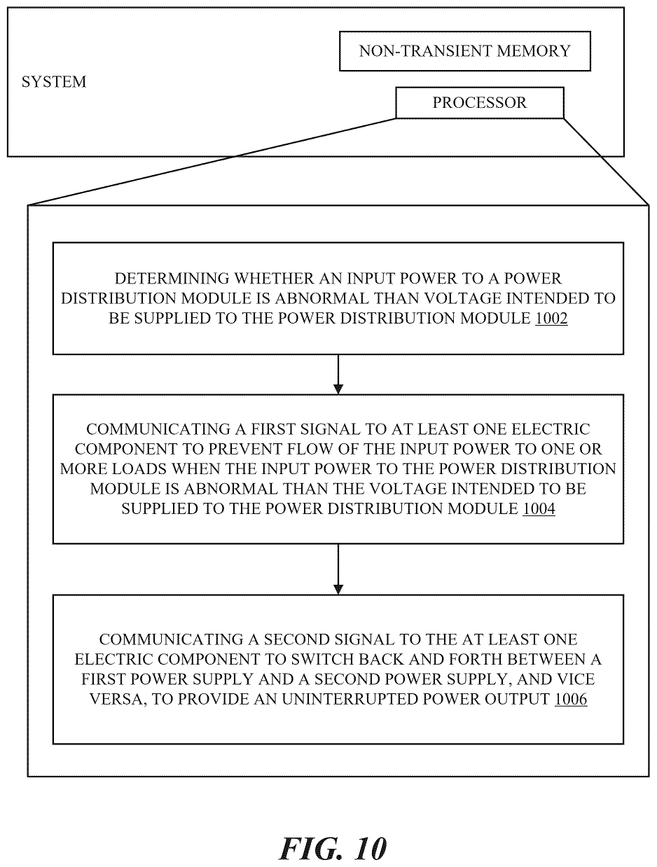

As an example, FIG. 10 illustrates a system for protecting loads against electric faults, according to one or more embodiments. The system comprises a processor. The processor storing instructions in non-transitory memory that, when executed, causes the processor to: determine whether an input power to a power distribution module is abnormal than voltage intended to be supplied to the power distribution module (at step 1002); communicate a first signal to at least one electric component to prevent flow of the input power to the one or more loads when the input power to the power distribution module is abnormal than the voltage intended to be supplied to the power distribution module (at step 1004); and communicate a second signal to the at least one electric component to switch between a first power supply and a second power supply, and vice versa, to provide an uninterrupted power output (at step 1006). In one embodiment, the processor further causes to: communicate a third signal to the at least one electric component to protect the one or more loads from at least one of overvoltage, overcurrent, reverse polarity, undervoltage, etc. In an embodiment, the first signal may be a signal to the at least one electric component to turn off their power to the load. The at least one electric component may be a component within the power distribution module. In an embodiment, the at least one electric component may be a component external to the power distribution module. Upon receiving the first signal, the at least one electric component turns off their power to the loads. In an embodiment, the second signal may be a signal to the at least one electric component to switch at least one of their connection between the first power supply and the second power supply.

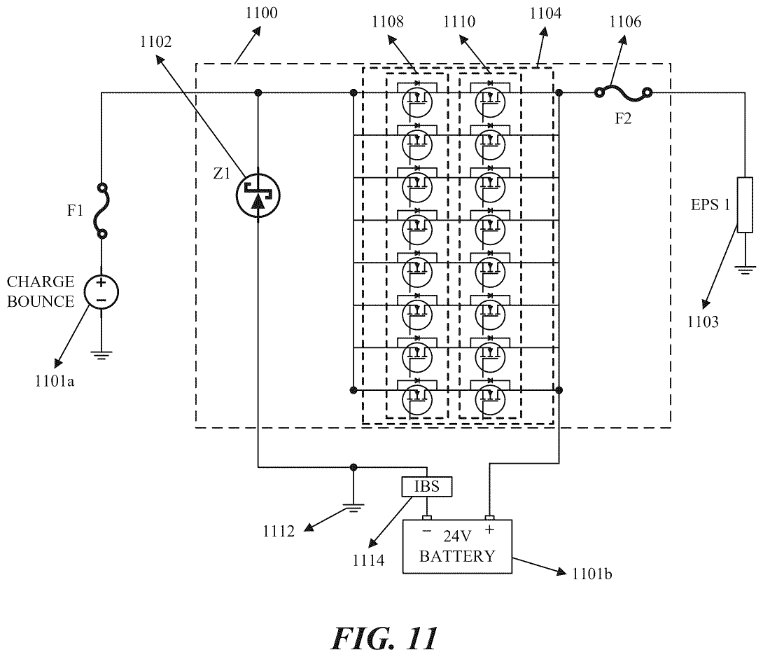

As an example, FIG. 11 illustrates a system for protecting loads against electric faults, according to one or more embodiments. The system comprises a power distribution module 1100, a first power supply 1101a, a second power supply 1101b, and a load 1103. The first power supply 1101a may be an alternator or a charge source or DC/DC converter. The second power supply 1101b may be a battery pack or a charge source. The first power supply 1101a and the second power supply 1101b may be identical components or non-identical components. The load 1103 may be a component in a vehicle (e.g., truck, car, etc.) that requires uninterrupted power. For example, the load 1103 may be an ASIL rated component (e.g., power steering).

The power distribution module 1100 comprises a Zener diode 1102, a field-effect transistor (FET) array 1104, and a fuse 1106. According to this embodiment, each of the diodes 204 and 404 in FIG. 2 and FIG. 4, respectively, is replaced with the FET array 1104. The FET array 1104 is used in place of the diode (204, 404 in FIG. 2 and FIG. 4, respectively) to ensure that a random hardware failure (FET failing short) does not result in the violation of load protection. The diode (204, 404 in FIG. 2 and FIG. 4, respectively) is adapted to provide instantaneous protection against one or more electric faults, while the FET array 1104 is adapted to provide gradual or delayed protection against the one or more electric faults (i.e., the FET array 1104 plays with timing and provides protection against the one or more electric faults). For example, the FET array 1104 enables the second power supply 1101b to act as a buffer for noise on the first power supply 1101a without running the undervoltage. Whenever there is fault with the first power supply 1101a, the power distribution module 1100 provides uninterrupted power through the second power supply 1101b.

The field-effect transistor (FET) array 1104 comprises a plurality of first FETs 1108 and a plurality of second FETs 1110. A plurality of first body diodes is connected across the plurality of first FETs 1108, respectively. A plurality of second body diodes is connected across the plurality of second FETs 1110, respectively. The plurality of first body diodes and the plurality of second body diodes may be adapted to block current flow from the second power supply 1101b to the first power supply 1101a. An anode of the Zener diode 1102 is connected to a ground terminal 1112. A cathode of the Zener diode 1102 is connected to a source terminal of the plurality of first FETs 1108. A drain terminal of the plurality of first FETs 1108 is connected to a source terminal of the plurality of second FETs 1110. A drain terminal of the plurality of second FETs 1110 is connected to a positive terminal of the second power supply 1101b. The one or more loads are connected to the drain terminal of the plurality of second FETs 1110 through the fuse 1106. A gate terminal of the plurality of first FETs 1108 and the plurality of second FETs 1110 may be fed through gate drivers. The plurality of first FETs 1108 may be connected in series with the plurality of second FETs 1110, respectively.

In one embodiment, the FET array is a MOSFET array. According to this embodiment, the plurality of first FETs is a plurality of first Metal Oxide Semiconductor Field-effect Transistors (MOSFET) and the plurality of second FETs is a plurality of second Metal Oxide Semiconductor Field-effect Transistors (MOSFET).

In one embodiment, the system may comprise an intelligent battery sensor (IBS) 1114. The intelligent battery sensor (IBS) 1114 is adapted to measure critical battery parameters like voltage, current, and temperature. The intelligent battery sensor (IBS) 1114 is adapted to monitor the health of the second power supply 1101b. The monitored parameters may be recorded onto a database.

In one embodiment, the power distribution module 1100 may operate as follows. The FETs used in this embodiment are the MOSFETs. The positive terminal of the first power supply 1101a is connected to the cathode terminal of the Zener diode 1102. Since it is the Zener diode 1102, it blocks current flow until the voltage across it reaches the Zener breakdown voltage. At this point, the Zener diode 1102 enters breakdown mode, allowing current to flow in the reverse direction and protects the load 1103 against the overvoltage. When power from the first power supply is less than the threshold voltage of the MOSFET, the MOSFET array does not conduct and protects the load 1103 against the undervoltage and reverse polarity. The threshold voltage is the minimum Gate-Source Voltage (V_{GS}) required to create a conductive channel in the MOSFET. In case of overcurrent scenario, the fuse 1106 blows out and protects the load 1103 against the overcurrent. In all the above-mentioned scenarios (overvoltage, undervoltage, reverse polarity, overcurrent, etc.), the input power from first power supply 1101a is not fed to the load 1103. The second power supply 1101b acts as a buffer. Whenever there is fault with the first power supply 1101a, the power distribution module 1100 provides uninterrupted power through the second power supply 1101b.

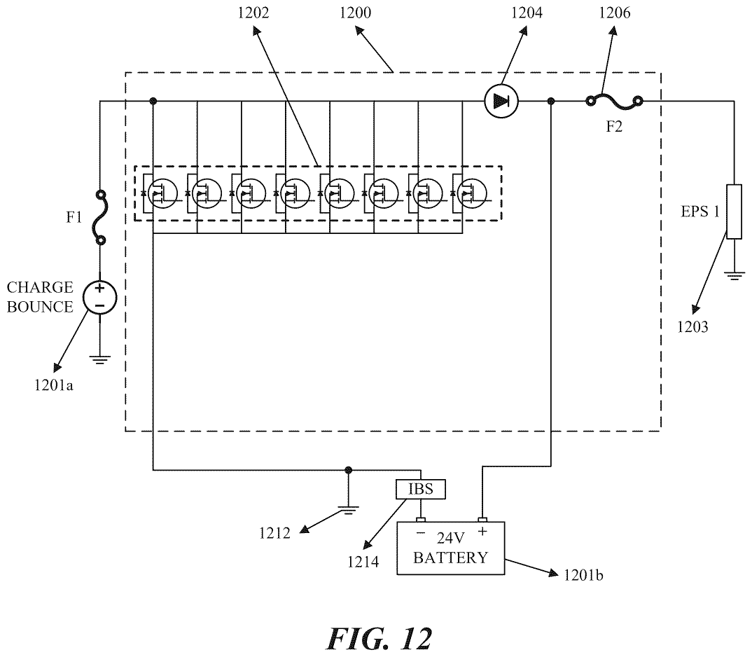

As an example, FIG. 12 illustrates a system for protecting loads against electric faults, according to one or more embodiments. The system comprises a power distribution module 1200, a first power supply 1201a, a second power supply 1201b, and a load 1203. The first power supply 1201a may be an alternator or a charge source or DC/DC converter. The second power supply 1201b may be a battery pack or a charge source. The first power supply 1201a and the second power supply 1201b may be identical components or non-identical components. The load 1203 may be a component in a vehicle (e.g., truck, car, etc.) that requires uninterrupted power. For example, the load 1203 may be an ASIL rated component (e.g., power steering).

The power distribution module 1200 comprises a field-effect transistor (FET) array 1202, a diode 1204 and a fuse 1206. The field-effect transistor (FET) array 1202 is used in place of the Zener diode (202, 402 in FIG. 2 and FIG. 4, respectively) to ensure that a random hardware failure (FET failing short) does not result in the violation of load protection. The field-effect transistor (FET) array 1202 comprises a plurality of FETs in which a plurality of body diodes is connected across the plurality of FETs, respectively. The plurality of body diodes may be adapted to block current flow from the second power supply 1201b to the first power supply 1201a. A source terminal of the plurality of FETs is connected to a ground terminal 1212 and a negative terminal of the second power supply 1201b. A drain terminal of the plurality of FETs is connected to an anode of the diode 1204. A gate terminal of the plurality of FETs may be fed through gate drivers. A cathode of the diode 1204 is connected to a positive terminal of the second power supply 1201b. The load 1203 is connected to the cathode of the diode 1204 through the fuse 1206.

In one embodiment, the FET array 1202 is a MOSFET array. According to this embodiment, the plurality of FETs is a plurality of Metal Oxide Semiconductor Field-effect Transistors (MOSFET).

In one embodiment, the system may comprise an intelligent battery sensor (IBS) 1214. The intelligent battery sensor (IBS) 1214 is adapted to measure critical battery parameters like voltage, current, and temperature. The intelligent battery sensor (IBS) 1214 is adapted to monitor the health of the second power supply 1201b. The monitored parameters may be recorded onto a database.

In one embodiment, the power distribution module 1200 may operate as follows. The FETs used in this embodiment are the MOSFETs. The positive terminal of the first power supply 1201a is connected to the drain terminal of the MOSFETs. Since these are the N-channel MOSFETs, the power flows from drain terminal to source terminal. When power from the first power supply exceeds the threshold voltage (Vth), the power flows from the drain terminal to the source terminal of the N-channel MOSFETs and protects the load 1203 against the overvoltage. When power from the first power supply 1201a is less than the threshold voltage (i.e., forward voltage of diode 1204), the diode 1204 does not conduct and protects the load 1203 against the undervoltage and reverse polarity. The diode 1204 conducts only when the input voltage exceeds the threshold voltage (i.e. forward voltage of diode 1204). The diode 1204 also does not conduct when there is reverse polarity. In case of an overcurrent scenario, the fuse 1206 blows out and protects the load 1203 against the overcurrent. In all the above-mentioned scenarios (overvoltage, undervoltage, reverse polarity, overcurrent, etc.), the input power from first power supply 1201a is not fed to the load 1203. The second power supply 1201b acts as a buffer. Whenever there is fault with the first power supply 1201a, the power distribution module 1200 provides uninterrupted power through the second power supply 1201b.

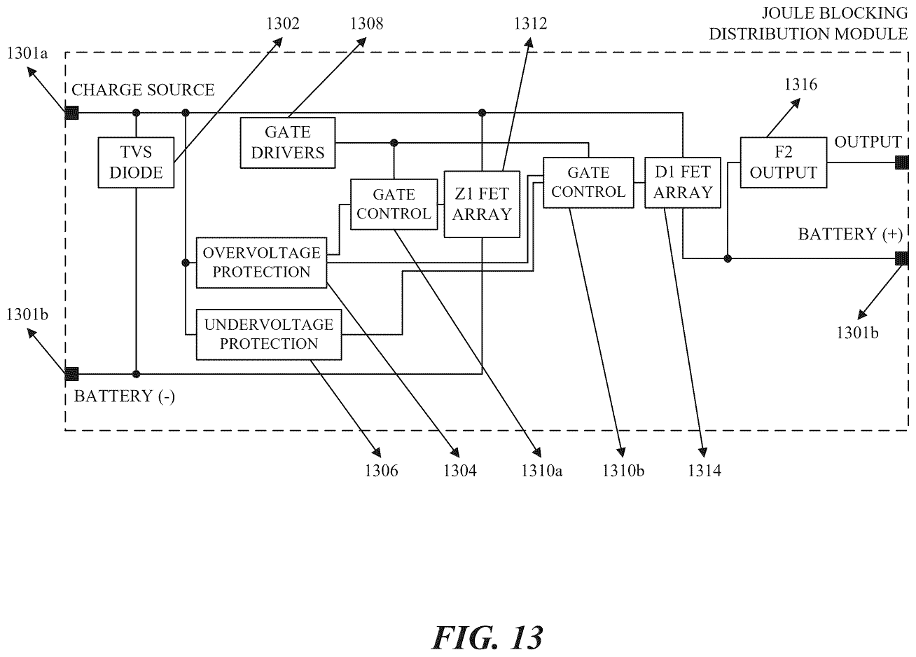

As an example, FIG. 13 illustrates a system for protecting loads against electric faults, according to one or more embodiments. The system comprises a power distribution module, a first power supply 1301a, a second power supply 1301b, and a load. The first power supply 1301a may be an alternator or a charge source or DC/DC converter. The second power supply 1301b may be a battery pack or a charge source. The first power supply 1301a and the second power supply 1301b may be identical components or non-identical components. The load may be a component in a vehicle (e.g., truck, car, etc.) that requires uninterrupted power. For example, the load may be an ASIL rated component (e.g., power steering).

The system further comprises a Transient Voltage Suppressor (TVS) diode 1302, an overvoltage protection element 1304, an undervoltage protection element 1306, and a gate driver 1308. The Transient Voltage Suppressor (TVS) diode 1302 is adapted to clamp charge source input voltage for predefined durations before Z1 circuit is triggered. The Transient Voltage Suppressor (TVS) diode 1302 protects the load from transient voltage spikes. The Transient Voltage Suppressor (TVS) diode 1302 prevents voltage spikes from exceeding a specified threshold by clamping them to a predefined level. The overvoltage protection element 1304 and the undervoltage protection element 1306 may be operational amplifiers/differential amplifiers that measure input voltage from the first power supply 1301a and provide its output to first gate control 1310a and second gate control 1310b. The gate driver 1308 may communicate a signal appropriately to the first gate control 1310a and the second gate control 1310b. The gate driver 1308 may be a single channel gate driver with two independent gate outputs for 12V/24 V automotive applications. The gate driver 1308 comprises two bidirectional high-side analog current sense interfaces with externally adjustable gain. The gate driver 1308 comprises a pull-down resistance of 3Ω and pull-up resistance of 50Ω for fast switching. The gate driver 1308 supports back-to-back MOSFET topologies (common drain and common source). The gate driver 1308 provides adjustable overcurrent/short-circuit protection.

The power distribution module comprises a first field-effect transistor (FET) array 1312 (Z1 FET array), a second field-effect transistor (FET) array 1314 (D1 FET array), and a fuse 1316. The first gate control 1310a may be associated with the first field-effect transistor (FET) array 1312 (Z1 FET array) to provide input to the gate terminal of the first field-effect transistor (FET) array 1312. The second gate control 1310b may be associated with the second field-effect transistor (FET) array 1314 (D1 FET array) to provide input to the gate terminal of the second field-effect transistor (FET) array 1314.

The first field-effect transistor (FET) array 1312 comprises a plurality of first FETs and a plurality of second FETs. A plurality of first body diodes connected across the plurality of first FETs, respectively, and a plurality of second body diodes connected across the plurality of second FETs, respectively. A drain terminal of the plurality of first FETs is connected to a source terminal of the plurality of second FETs. The plurality of first FETs is connected in series with the plurality of second FETs, respectively. The first field-effect transistor (FET) array 1312 functions as described above in FIG. 11.

The second field-effect transistor (FET) array 1314 comprises a plurality of third FET. A plurality of third body diodes is connected across a plurality of third FETs, respectively. The second field-effect transistor (FET) array 1314 functions as described above in FIG. 12.

The load is connected to the second field-effect transistor (FET) array 1314 via the fuse 1316. The power distribution module protects the load against the electric faults such as overvoltage, undervoltage, reverse polarity, and overcurrent. The power distribution module further provides uninterrupted power output to the load.

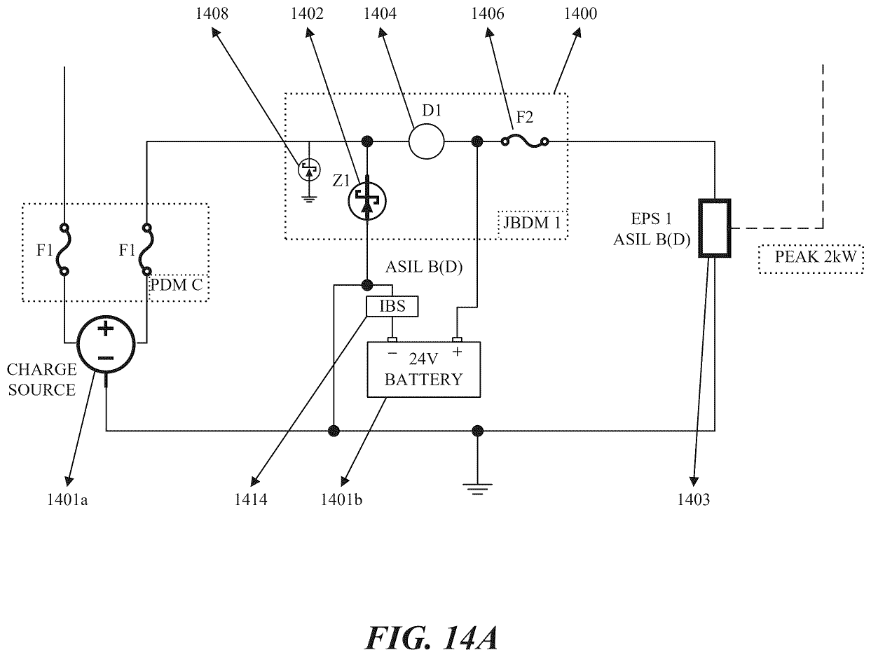

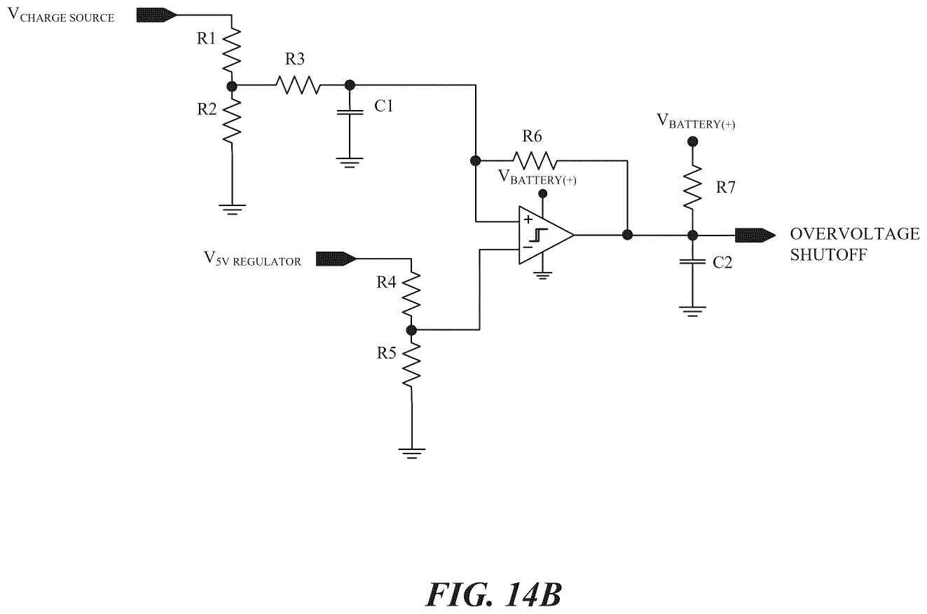

As an example, FIG. 14A illustrates a system for protecting loads against overvoltage, according to one or more embodiments. The system comprises a power distribution module 1400, a first power supply 1401a, a second power supply 1401b, and a load 1403. The first power supply 1401a may be an alternator or a charge source or DC/DC converter. The second power supply 1401b may be a battery pack or a charge source. The first power supply 1401a and the second power supply 1401b may be identical components or non-identical components. The load 1403 may be a component in a vehicle (e.g., truck, car, etc.) that requires uninterrupted power. For example, the load 1403 may be an ASIL rated component (e.g., power steering).

The power distribution module 1400 comprises a Zener diode 1402, a diode 1404, and a fuse 1406. The connections between the Zener diode 1402, the diode 1404, and the fuse 1406 are already described in detail in above figures (e.g., FIG. 2 and FIG. 4). An analog circuit (e.g., a crowbar circuit) may be used in place of Zener diode 1402 to provide protection against the overvoltage condition. The crowbar circuit is shown in detail in FIG. 14B. If overvoltage persists, the crowbar circuit is activated to blow F1. The power distribution module 1400 may comprise a Transient Voltage Suppressor (TVS) diode 1408. The Transient Voltage Suppressor (TVS) diode 1408 is adapted to clamp charge source input voltage for predefined durations before the Zener diode 1402 or the crowbar circuit is triggered. The Transient Voltage Suppressor (TVS) diode 1408 protects the load from transient voltage spikes. The Transient Voltage Suppressor (TVS) diode 1408 prevents voltage spikes from exceeding a specified threshold by clamping them to a predefined level.

In one embodiment, the system may comprise an intelligent battery sensor (IBS) 1414. The intelligent battery sensor (IBS) 1514 has been described already above (e.g., FIG. 11 and FIG. 12).

FIG. 14B illustrates a circuit for protecting loads against overvoltage, according to one or more embodiments. The circuit shown is an overvoltage protection circuit, designed to protect a battery or load from excessively high voltage. The circuit monitors the voltage across the battery and shuts off the connection to the load if the voltage exceeds a predefined threshold. The circuit uses a voltage divider (R1, R2) to scale the input voltage to a level suitable for comparison, while an RC filter (R3, C1) removes noise, ensuring stable operation. The operational amplifier (op-amp) functions as a comparator, comparing the scaled voltage at its inverting input with a reference voltage provided by a stable voltage regulator configured with R4 and R5. If the input voltage exceeds the threshold, the divided voltage surpasses the reference voltage, causing the op-amp output to switch high, which triggers the overvoltage shutoff mechanism to disconnect the load or battery, preventing damage. A feedback resistor (R6) introduces hysteresis to stabilize the circuit by preventing rapid switching near the threshold voltage, while a pull-down resistor (R7) ensures proper biasing and avoids false triggering. Additionally, capacitor C2 filters noise at the op-amp output, ensuring a clean control signal for the shutoff mechanism.

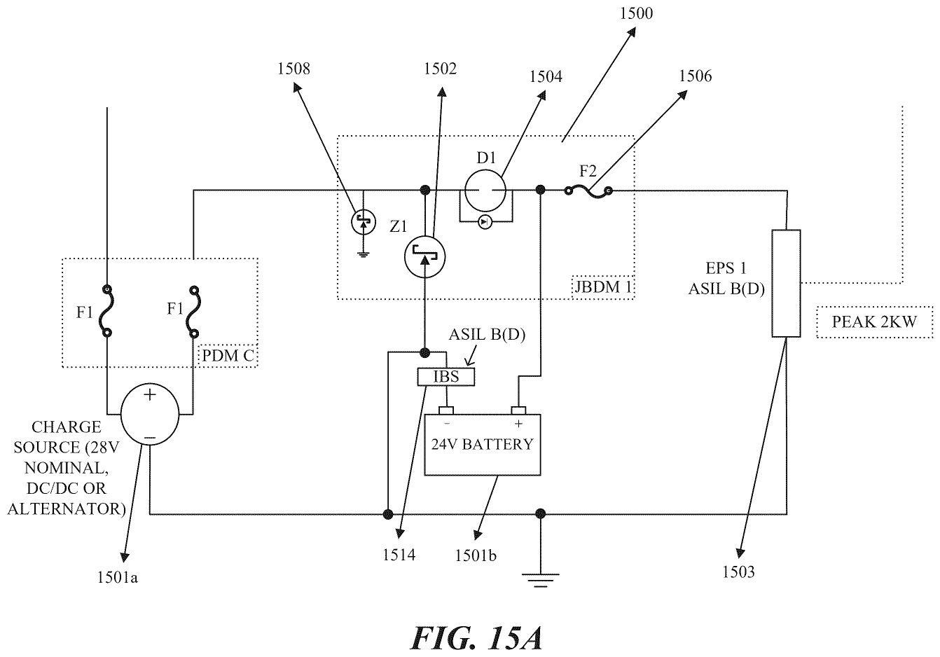

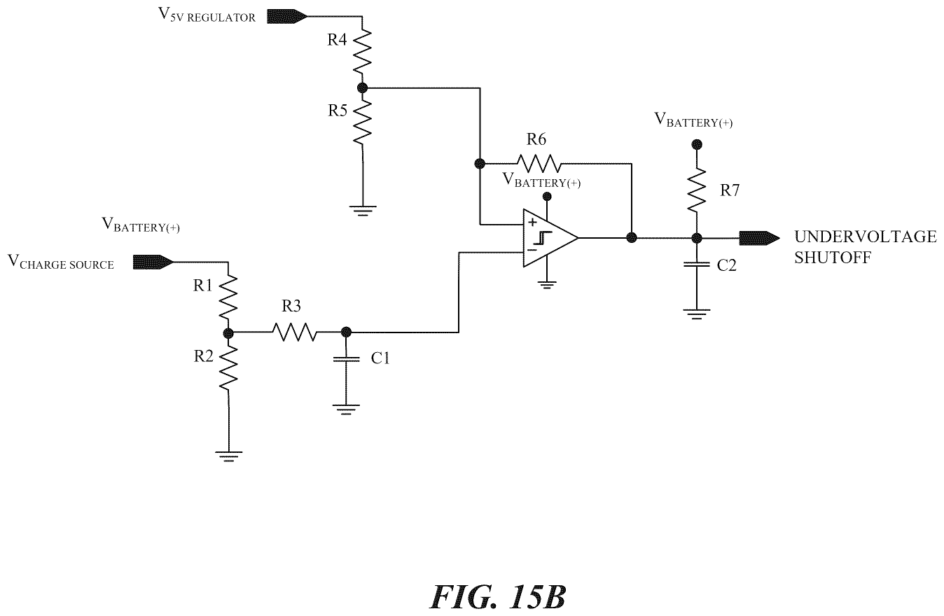

As an example, FIG. 15A illustrates a system for protecting loads against undervoltage, according to one or more embodiments. The system comprises a power distribution module 1500, a first power supply 1501a, a second power supply 1501b, and a load 1503. The first power supply 1501a may be an alternator or a charge source or DC/DC converter. The second power supply 1501b may be a battery pack or a charge source. The first power supply 1501a and the second power supply 1501b may be identical components or non-identical components. The load 1503 may be a component in a vehicle (e.g., truck, car, etc.) that requires uninterrupted power. For example, the load 1503 may be an ASIL rated component (e.g., power steering). In one embodiment, the system may comprise an intelligent battery sensor (IBS) 1514. The intelligent battery sensor (IBS) 1514 has been described already above e.g., FIG. 11 and FIG. 12).

The power distribution module 1500 comprises a Zener diode 1502, a diode 1504, and a fuse 1506. The connections between the Zener diode 1502, the diode 1504, and the fuse 1506 are already described in detail in above figures (e.g., FIG. 2 and FIG. 4). An analog circuit (e.g., a crowbar circuit) may be used in place of the diode 1504 to provide protection against the undervoltage condition. The crowbar circuit is shown in detail in FIG. 15B. The power distribution module 1500 may comprise a Transient Voltage Suppressor (TVS) diode 1508. The Transient Voltage Suppressor (TVS) diode 1508 is adapted to clamp charge source input voltage for predefined durations before the Zener diode 1502 or the crowbar circuit is triggered. The Transient Voltage Suppressor (TVS) diode 1508 protects the load from transient voltage spikes. The Transient Voltage Suppressor (TVS) diode 1508 prevents voltage spikes from exceeding a specified threshold by clamping them to a predefined level.

FIG. 15B illustrates a circuit for protecting loads against undervoltage, according to one or more embodiments. The circuit shown is an undervoltage shutoff circuit, designed to protect from over-discharge. The circuit comprises a voltage divider, an operational amplifier, a positive feedback mechanism, and a noise filtering circuit. (R1 and R2) together form the voltage divider. The voltage divider is configured to scale the input voltage from the charge source to generate a reference voltage (i.e., level suitable for comparison), while the noise filtering circuit (RC filter i.e., R3 and C1) removes noise, ensuring a stable input for the operational amplifier (op-amp). The op-amp functions as a comparator, comparing the reference voltage from the divider with the battery voltage. When the battery voltage is above the set threshold, the op-amp output remains high, allowing normal operation. If the battery voltage drops below the threshold, the op-amp output switches low, triggering the undervoltage shutoff mechanism to disconnect the battery and protect it. Positive feedback via R6 introduces hysteresis, preventing rapid switching near the threshold voltage and ensuring stable operation. Additional components like pull-down resistors (R5 and R7) maintain proper circuit biasing, while capacitors (C1 and C2) further suppress noise. This circuit is widely used in battery protection systems, energy storage solutions, and uninterruptible power supplies to ensure batteries remain within reliable operating conditions.

Aspects of the present disclosure include a system having a first power supply, a second power supply, and a power distribution module, wherein the power distribution module is operable to determine one or more electric faults and protect one or more loads from the one or more electric faults, and wherein the power distribution module is operable to switch between the first power supply and the second power supply, and vice versa, to provide an uninterrupted power output.

Aspects of the present disclosure include the system above, wherein the power distribution module includes one or more overvoltage protection circuits, one or more undervoltage protection circuits, and one or more overcurrent protection circuits.

Aspects of the present disclosure include any of the systems above, wherein the power distribution module includes one or more Zener diodes, and one or more diodes, wherein a first anode of the one or more Zener diodes is connected to a ground terminal, and wherein a cathode of the one or more Zener diodes is connected to a second anode of the one or more diodes.

Aspects of the present disclosure include any of the systems above, wherein the one or more overvoltage protection circuits includes one or more crowbar circuits.

Aspects of the present disclosure include any of the systems above, wherein the one or more overvoltage protection circuits includes one or more Zener diodes.

Aspects of the present disclosure include any of the systems above, wherein the one or more overvoltage protection circuits includes one or more Zener regulators.

Aspects of the present disclosure include any of the systems above, wherein the one or more overvoltage protection circuits includes an array of Zener diodes.

Aspects of the present disclosure include any of the systems above, wherein the one or more overvoltage protection circuits includes one or more shunt regulators.

Aspects of the present disclosure include any of the systems above, wherein the one or more overvoltage protection circuits includes one or more metal-oxide-semiconductor field-effect transistors (MOSFETs).

Aspects of the present disclosure include any of the systems above, wherein the one or more overvoltage protection circuits includes one or more varistors.

Aspects of the present disclosure include any of the systems above, wherein the one or more overvoltage protection circuits includes one or more circuit breakers.

Aspects of the present disclosure include any of the systems above, wherein the one or more overcurrent protection circuits includes one or more fuses.

Aspects of the present disclosure include any of the systems above, wherein the one or more overcurrent protection circuits includes one or more surge protection thermistors.

Aspects of the present disclosure include any of the systems above, wherein the one or more overcurrent protection circuits includes one or more electromechanical circuit breakers.

Aspects of the present disclosure include any of the systems above, wherein the one or more overcurrent protection circuits includes one or more solid state switches.

Aspects of the present disclosure include any of the systems above, wherein the one or more undervoltage protection circuits includes one or more undervoltage relays.

Aspects of the present disclosure include any of the systems above, wherein the one or more undervoltage protection circuits includes one or more diodes.

Aspects of the present disclosure include any of the systems above, wherein the first power supply is a power source that generates power.

Aspects of the present disclosure include any of the systems above, wherein the second power supply is an energy storage system that stores power.

Aspects of the present disclosure include any of the systems above, wherein the second power supply is one of a battery pack and a power bank.

Aspects of the present disclosure include any of the systems above, wherein the first power supply is an energy storage system that stores power.

Aspects of the present disclosure include any of the systems above, wherein the second power supply is a power source that generates power.

Aspects of the present disclosure include any of the systems above, wherein the power distribution module further includes one or more reverse polarity protection components.

Aspects of the present disclosure include any of the systems above, wherein the one or more reverse polarity protection components includes one or more diodes.

Aspects of the present disclosure include any of the systems above, wherein the one or more loads includes Automotive Safety Integrity Level (ASIL) rated systems.

Aspects of the present disclosure include any of the systems above, wherein the one or more loads includes a power steering of a vehicle.

Aspects of the present disclosure include any of the systems above, wherein the power distribution module includes a microprocessor that is configured to switch between the first power supply and the second power supply, and vice versa, to provide the uninterrupted power output.

Aspects of the present disclosure include any of the systems above, wherein the power distribution module prevents flow of input power from the second power supply to the power distribution module when an input voltage to the power distribution module is less than voltage supplied by the second power supply.

Aspects of the present disclosure include any of the systems above, wherein the one or more undervoltage protection circuits prevents flow of reverse polarity power to the power distribution module.

Aspects of the present disclosure include any of the systems above, wherein the power distribution module switches from the second power supply to the first power supply to provide the uninterrupted power output to the one or more loads.

Aspects of the present disclosure include any of the systems above, wherein the power distribution module includes one or more Zener diodes, and a field-effect transistor (FET) array that includes a plurality of first FETs and a plurality of second FETs, wherein a plurality of first body diodes connected across the plurality of first FETs, respectively, and a plurality of second body diodes connected across the plurality of second FETs, respectively, wherein an anode of the one or more Zener diodes is connected to a ground terminal, wherein a cathode of the one or more Zener diodes is connected to a source terminal of the plurality of first FETs, and wherein a drain terminal of the plurality of first FETs is connected to a source terminal of the plurality of second FETs.

Aspects of the present disclosure include any of the systems above, wherein the plurality of first FETs is connected in series with the plurality of second FETs, respectively.

Aspects of the present disclosure include any of the systems above, wherein the FET array is a MOSFET array.

Aspects of the present disclosure include any of the systems above, wherein the plurality of first FETs is a plurality of first Metal Oxide Semiconductor Field-effect Transistors (MOSFET) and the plurality of second FETs is a plurality of second Metal Oxide Semiconductor Field-effect Transistors (MOSFET).

Aspects of the present disclosure include any of the systems above, wherein the drain terminal of the plurality of second FETs is connected to a positive terminal of a battery pack.

Aspects of the present disclosure include any of the systems above, wherein the one or more loads are connected to the drain terminal of the plurality of second FETs through one or more overcurrent protection circuits.

Aspects of the present disclosure include any of the systems above, wherein the power distribution module includes a field-effect transistor (FET) array that includes a plurality of body diodes connected across a plurality of FETs, respectively, and one or more diodes, wherein a drain terminal of the plurality of FETs is connected to an anode of the one or more diodes.

Aspects of the present disclosure include any of the systems above, wherein the FET array is a MOSFET array.

Aspects of the present disclosure include any of the systems above, wherein the plurality of FETs is a plurality of Metal Oxide Semiconductor Field-effect Transistors (MOSFET).

Aspects of the present disclosure include any of the systems above, wherein a cathode of the one or more diodes is connected to a positive terminal of a battery pack.

Aspects of the present disclosure include any of the systems above, wherein the one or more loads are connected to the cathode of the one or more diodes through one or more overcurrent protection circuits.

Aspects of the present disclosure include any of the systems above, wherein a source terminal of the plurality of FETs is connected to a ground terminal.

Aspects of the present disclosure include any of the systems above, wherein the power distribution module includes a first field-effect transistor (FET) array, and a second field-effect transistor (FET) array.

Aspects of the present disclosure include any of the systems above, wherein the first field-effect transistor (FET) array includes a plurality of first FETs and a plurality of second FETs, wherein a plurality of first body diodes connected across the plurality of first FETs, respectively, and a plurality of second body diodes connected across the plurality of second FETs, respectively, wherein a drain terminal of the plurality of first FETs is connected to a source terminal of the plurality of second FETs, and wherein the plurality of first FETs is connected in series with the plurality of second FETs, respectively.

Aspects of the present disclosure include any of the systems above, wherein the second field-effect transistor (FET) array includes a plurality of third body diodes connected across a plurality of third FETs, respectively.

Aspects of the present disclosure include any of the systems above, wherein the plurality of third FETs is a plurality of MOSFETs.

Aspects of the present disclosure include any of the systems above, wherein the system includes a transient voltage suppressor (TVS) diode, a gate driver, an overvoltage protection element, and an undervoltage protection element.

Aspects of the present disclosure include any of the systems above, wherein the transient voltage suppressor (TVS) diode is adapted to clamp charge source input voltage for a predefined duration.

Aspects of the present disclosure include any of the systems above, wherein the system includes an intelligent battery sensor (IBS).

Aspects of the present disclosure include a method including determining, by a power distribution module, whether an input power to the power distribution module is abnormal than voltage intended to be supplied to the power distribution module, preventing, by the power distribution module, flow of the input power to one or more loads when the input power to the power distribution module is abnormal than the voltage intended to be supplied to the power distribution module, and switching, by the power distribution module, between a first power supply and a second power supply, and vice versa, to provide an uninterrupted power output.

Aspects of the present disclosure include the method above, wherein the method further includes protecting the one or more loads, by the power distribution module, from one or more electric faults through the power distribution module.

Aspects of the present disclosure include any of the methods above, wherein the power distribution module includes one or more overvoltage protection circuits, one or more undervoltage protection circuits, and one or more overcurrent protection circuits.

Aspects of the present disclosure include any of the methods above, wherein the power distribution module includes a microprocessor that is configured to switch between the first power supply and the second power supply, and vice versa, to provide the uninterrupted power output.

Aspects of the present disclosure include a non-transitory computer readable storage medium, storing a sequence of instructions, which when executed by a processor causes the processor to perform the steps of determining whether an input power to a power distribution module is abnormal than voltage intended to be supplied to the power distribution module, preventing flow of the input power to one or more loads when the input power to the power distribution module is abnormal than the voltage intended to be supplied to the power distribution module, and switching between a first power supply and a second power supply, and vice versa, to provide an uninterrupted power output.

Aspects of the present disclosure include the non-transitory computer readable storage medium above, further causes: protecting the one or more loads from one or more electric faults through the power distribution module.

The embodiments described herein include mere examples of systems and methods. It is, of course, not possible to describe every conceivable combination of components and/or methods for purposes of describing the one or more embodiments, but one with ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings, such terms are intended to be inclusive in a manner similar to the term “comprising,” as “comprising” is interpreted when employed as a transitional word in a claim.

The present disclosure may be embodied in other specific forms without departing from its spirit or characteristics. The embodiments described are to be considered in all respects only as illustrative and not restrictive. The scope is, therefore, indicated by the appended claims rather than by the foregoing description. All changes which come within the meaning and range of equivalency of the claims are to be embraced within their scope.

Other embodiments are also within the scope of the following claims.

Although various embodiments incorporate the teachings described in detail herein, those skilled in the art can readily devise many other varied embodiments that still incorporate these teachings. For example, the embodiments are limited to Zenner and regular diode components, but could include circuits (e.g., MOSFET in combination with other electrical components) that accomplish protecting the load against electric faults and to provide uninterrupted power. The embodiments described are all applicable to all types of loads (e.g., ASIL rated systems, automotive systems, etc.).

Other specific forms may embody the present disclosure without departing from its spirit or characteristics. The embodiments described are in all respects illustrative and not restrictive. Therefore, the appended claims, rather than the description herein, indicate the scope of the disclosure. All variations which come within the meaning and range of equivalency of the claims are within their scope.

All documents (patents, patent publications or other publications) mentioned in the specification are incorporated herein in their entirety by reference.

What we claim is:

1. A system comprising:
a first power supply;
a second power supply; and
a power distribution module;
wherein the power distribution module is operable to determine one or more electric faults and protect one or more loads from the one or more electric faults; and
wherein the power distribution module is operable to switch between the first power supply and the second power supply, and vice versa, to provide an uninterrupted power output.

2. The system of claim 1, wherein the power distribution module comprises:
one or more overvoltage protection circuits;
one or more undervoltage protection circuits; and
one or more overcurrent protection circuits.

3. The system of claim 2, wherein the one or more overvoltage protection circuits comprises at least one of one or more crowbar circuits, one or more Zener diodes, one or more Zener regulators, an array of Zener diodes, one or more shunt regulators, one or more metal-oxide-semiconductor field-effect transistors (MOSFETs), one or more varistors, or one or more circuit breakers.

4. The system of claim 2, wherein the one or more overcurrent protection circuits comprises at least one of one or more fuses, one or more surge protection thermistors, one or more electromechanical circuit breakers, or one or more solid state switches.

5. The system of claim 2, wherein the one or more undervoltage protection circuits comprises at least one of one or more undervoltage relays or one or more diodes.

6. The system of claim 1, wherein the power distribution module comprises:
one or more Zener diodes; and
one or more diodes;
wherein a first anode of the one or more Zener diodes is connected to a ground terminal; and
wherein a cathode of the one or more Zener diodes is connected to a second anode of the one or more diodes.

7. The system of claim 1, wherein the first power supply is a power source that generates power or an energy storage system that stores power.

8. The system of claim 1, wherein the second power supply is a power source that generates power, an energy storage system that stores power, a battery pack, or a power bank.

9. A method, comprising:
determining, by a power distribution module, whether an input power to the power distribution module is a voltage intended to be supplied to the power distribution module;
preventing, by the power distribution module, the input power from flowing to one or more loads in response to the input power being different than the voltage intended to be supplied to the power distribution module; and
switching, by the power distribution module, from a first power supply to a second power supply to provide an uninterrupted power output.

10. The method of claim 9, further comprises protecting the one or more loads, by the power distribution module, from one or more electric faults through the power distribution module.

11. The method of claim 9, wherein the power distribution module comprises:
one or more overvoltage protection circuits;
one or more undervoltage protection circuits; and
one or more overcurrent protection circuits.

12. The method of claim 11, wherein the one or more overvoltage protection circuits comprises at least one of one or more crowbar circuits, one or more Zener diodes, one or more Zener regulators, an array of Zener diodes, one or more shunt regulators, one or more metal-oxide-semiconductor field-effect transistors (MOSFETs), one or more varistors, or one or more circuit breakers.

13. The method of claim 11, wherein the one or more overcurrent protection circuits comprises at least one of one or more fuses, one or more surge protection thermistors, one or more electromechanical circuit breakers, or one or more solid state switches.

14. The method of claim 11, wherein the one or more undervoltage protection circuits comprises at least one of one or more undervoltage relays or one or more diodes.

15. The method of claim 11, wherein switching from the first power supply to the second power supply comprises switching, by a microprocessor of the power distribution module, to switch from the first power supply to the second power supply to provide the uninterrupted power output.

16. A non-transitory computer readable medium storing instructions that, when executed by a processor of a power distribution module, cause the processor to:
determine whether an input power to the power distribution module is a voltage intended to be supplied to the power distribution module;
preventing the input power from flowing to one or more loads in response to the input power being different than the voltage intended to be supplied to the power distribution module; and
switching from a first power supply to a second power supply to provide an uninterrupted power output.

17. The non-transitory computer readable medium of claim 16, wherein the power distribution module comprises:
one or more overvoltage protection circuits;
one or more undervoltage protection circuits; and
one or more overcurrent protection circuits.

18. The non-transitory computer readable medium of claim 17, wherein the one or more overvoltage protection circuits comprises at least one of one or more crowbar circuits, one or more Zener diodes, one or more Zener regulators, an array of Zener diodes, one or more shunt regulators, one or more metal-oxide-semiconductor field-effect transistors (MOSFETs), one or more varistors, or one or more circuit breakers.

19. The non-transitory computer readable medium of claim 17, wherein the one or more overcurrent protection circuits comprises at least one of one or more fuses, one or more surge protection thermistors, one or more electromechanical circuit breakers, or one or more solid state switches.

20. The non-transitory computer readable medium of claim 17, wherein the one or more undervoltage protection circuits comprises at least one of one or more undervoltage relays or one or more diodes.
